(19) United States
(12) Patent Application Publication
(10) Pub. No.: US 2024/0289870 A1
(43) Pub. Date: Aug. 29, 2024

(54) RE-ORDER AND BUYING MANAGEMENT SYSTEM FOR SPECIALTY RETAILERS

(71) Applicant: TIna LOYD, Dallas, TX (US)

(72) Inventor: TIna LOYD, Dallas, TX (US)

(21) Appl. No.: 18/587,329

(22) Filed: Feb. 26, 2024

Related U.S. Application Data
(60) Provisional application No. 63/448,080, filed on Feb. 24, 2023.

(51) Int. Cl. G06Q 30/0601

(52) U.S. Cl. CPC G06Q 30/0643; G06Q 30/0635

(57) ABSTRACT

A retailer purchase order and inventory management system integrating customer data and purchase order information sourced to various vendors and purchased from online and brick and mortar retail locations. Customer information and purchase requests are collected by merchant devices and stored in data stores of a merchant platform. Visual representations and reports of products and on order, on hand and sold units of such products are aggregated and presented to the merchant via various reporting screens and user interfaces upon user request.

This application claims priority to U.S. Provisional Application No. 63/448,080 filed Feb. 24, 2023, which is incorporated in its entirety herein by reference.

### BACKGROUND OF INVENTION

### Field of the Invention

The present invention relates generally to commerce systems, and more specifically, to a re-ordering and buying management system for specialty retailers that allows for efficient processing of customer orders and information, inventory tracking, and product delivery information accommodating customer purchases from different settings in the ordering and retail transaction processes.

### BRIEF SUMMARY

Commerce systems are well known in the art and are effective means to enabled multiple parties to transfer goods, services, commodities or the like between them. Many conventional commerce systems allow for both sales and product ordering from conventional brick and mortar retailer computer devices and on-line remote purchasing and product ordering from a user's device. Such user's device includes a smart phone, tablet, personal computer or other suitable personal digital device. Issues arise when disparate platforms are employed with respect to the brick and mortar and online retailer sales settings. Often for higher-end or custom products, various data including user information is collected by the merchant. The method of gathering and storing such user or other information for many merchants is challenging in both the online context and the brick and mortar setting. Some merchants who have traditionally been brick and mortar operations have antiquated legacy systems for collecting user data, managing inventory, tracking customer orders and the like. The e-commerce side of the retail business presents the challenge of marrying legacy order placement, order receipt, inventory and delivery tracking system with its e-commerce counterpart. Many merchants opt to support two separate systems, due to the lack of a platform that will accommodate the two very different types of sales contexts. What is needed, therefore, is a platform that invokes efficient customer information data input and updating, order receipt and fulfillment, inventory tracking and adjustment, and order status and other events in the order fulfilment process from the various computer terminals associated with the retailer.

For various retailers, particularly small business, encumbering resources such as retail space and money in large quantities of inventory is a problem. The presently described re-ordering and buying management system provides users with the at-a-glance ability to make regular and periodic (weekly, monthly, etc.) replenishment of goods via the robust re-order tools and interfaces described herein that provide images and real time data of a product of interest. Through the various interfaces that give users a “deep dive” into the styles, colors and sizes of a particular vendor, and the items that are on hand, on order, special ordered, retailers make fast and accurate re-ordering decisions.

Accordingly, although great strides have been made in the area of processing and managing traditional and e-commerce retail systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of a network including a merchant re-ordering and buying management system according to an embodiment.

FIG. 2A depicts a merchant order tracking screen of a re-ordering and buying management system for specialty retailers according to an embodiment.

FIG. 2B depicts an on hand table of a re-ordering and buying management system for specialty retailers according to an embodiment.

FIG. 3A depicts an on order table of a re-ordering and buying management system for specialty retailers according to an embodiment.

FIG. 3B depicts an on order table of a re-ordering and buying management system for specialty retailers according to an embodiment.

FIG. 3C depicts an on order screen of re-ordering and buying management system for specialty retailers according to an embodiment.

FIG. 4A depicts a purchase order interface of re-ordering and buying management system for specialty retailers according to an embodiment.

FIG. 4B depicts an add purchase order interface of a re-ordering and buying management system for specialty retailers according to an embodiment.

FIG. 4C depicts re-order interface of a re-ordering and buying management system for specialty retailers according to an embodiment.

FIG. 5A depicts a specials on hand interface of a re-ordering and buying management system for specialty retailers according to an embodiment.

FIG. 5B depicts a specials on order table interface of a re-ordering and buying management system for specialty retailers according to an embodiment.

FIG. 6 depicts a past complete report screen of a re-ordering and buying management system for specialty retailers according to an embodiment.

FIG. 7A depicts a full inventory screen of a re-ordering and buying management system for specialty retailers according to an embodiment.

FIG. 7B depicts a full inventory screen of a re-ordering and buying management system for specialty retailers according to an embodiment.

FIG. 8 depicts a customer alerts screen view generated by a re-ordering and buying management system for specialty retailers according to an embodiment.

FIG. 9A depicts a purchase order screen generated by a re-ordering and buying management system for specialty retailers according to an embodiment.

FIG. 9B depicts a purchase order screen generated by a re-ordering and buying management system for specialty retailers according to an embodiment.

FIG. 9C depicts a purchase order screen generated by a re-ordering and buying management system for specialty retailers according to an embodiment.

FIG. 9D depicts a purchase order screen generated by a re-ordering and buying management system for specialty retailers according to an embodiment.

FIG. 10 depicts a sales history interface generated by a re-ordering and buying management system for specialty retailers according to an embodiment.

FIG. 11 depicts a style addition interface generated by a re-ordering and buying management system for specialty retailers according to an embodiment.

FIG. 12 depicts components of a customer check in screen as presented to the user of a re-ordering and buying management system for specialty retailers according to an embodiment.

FIG. 13 depicts a pre-population feature of the enrollment screen of a specialty retailers re-ordering and buying management system according to an embodiment.

FIG. 14 depicts an event report generated by a re-ordering and buying management system for specialty retailers according to an embodiment.

FIG. 15 is a flow diagram of an order process performed according to an embodiment of a re-ordering and buying management system for specialty retailers.

FIG. 16 is a flow diagram of a purchase order process performed according to an embodiment of a re-ordering and buying management system for specialty retailers.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiments disclosed, but on the contrary, the intention is to cover all modifications, equivalents, and alternatives falling within the spirit and scope of the present application as defined by the appended claims.

### DETAILED DESCRIPTION OF THE EMBODIMENTS

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional retail purchase, order, re-order, inventory and fulfilment tracking systems when there is a historical brick and mortar component. Specifically, the re-ordering and buying management system for specialty retailers described herein is the ability it provides users to make educated and informed buying decisions, such as operators or a specialty retailer, through the user interfaces described herein, including the images of the retailer item and the product information details presented on one screen. As will be described, the various user interfaces include selectable items of information that when selected by the user provide more detailed views of an item. This is particularly advantageous in the item re-ordering process. The interfaces providing layers of details concerning the amount of inventory on hand and on order and historical sales information. For the clothing retailer, this information is provided according to the products of a particular designer, down to a particular item color and size. In particular, the capability to make informed decisions on re-ordering stock in a timely fashion and accurately allows retailers to make a small investment up front in inventory in an open order and wisely re-invest in the correct product due the details of the selling of the product by seeing all variables at once. The variables regarding the re-ordered item decision include when the is scheduled to arrive, when it arrives, when like items sold, the time to sell, and the colors and sizes of these items. These variables provide the retailers with the tools necessary to make a wise decision regarding reinvestment in the item and provides the retailer with the tools to do so with information at a glance in a quick and efficient manner based on real time data concerning the item of interest.

The embodiments of the invention herein described provides efficient collection of information pertinent to the transaction regardless of whether the purchase is made online or in a brick and mortar location. In addition, the invention of the present application enables the management of product inventory, purchase order generation and customer data updating as well as generation of custom reports. The presently described re-ordering and buying management system for specialty retailers is highly customizable to accommodate the type of product(s) sold by a merchant and unique attributes of such products. These and other unique features of the system and method of use are discussed below and illustrated in the accompanying drawings.

Ease of use by various retailer team members in the retail setting is another advantage of the presently described re-order and buying management system. The layout of product, sales, on hand inventory and historical sales information is presented to team member users, from sales staff on the retail floor, to backroom inventory control staff, to buyers, to management via the various user interfaces described herein provide simple and fast item information intake by team members. Various interfaces include images of the items of interest, allowing users to enter relevant data and make selections via a single user interface screen.

Various retailers endure busy selling seasons. This is particularly so in formal and bridal wear retailers that are extremely busy in the January to April months meeting customer demands for weddings and proms. The presently described re-ordering and buying management system gives retailers the ability to stay on top of and make accurate item re-orders and process other specialty orders quickly during these times when staff and resources are taxed.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

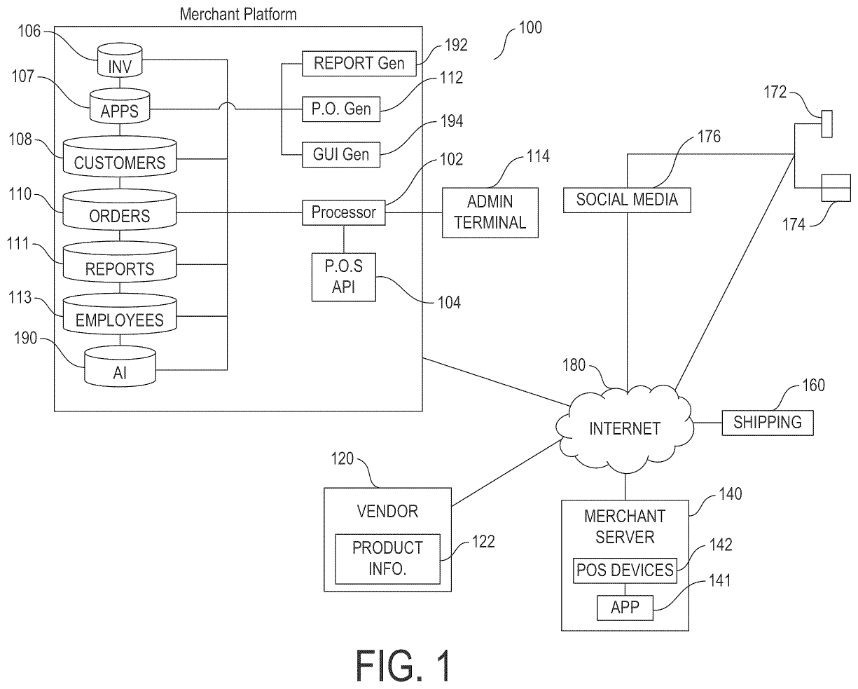

Referring now to the drawings wherein like reference characters identify corresponding or similar elements throughout the several views, FIG. 1 depicts a network diagram in which a merchant computer platform having a processor in accordance with a preferred embodiment of the present re-ordering and buying management system for specialty retailers re-ordering and buying management system for specialty retailers operates. It will be appreciated that merchant platform and re-ordering and buying management system for specialty retailers overcomes one or more of the above-listed problems commonly associated with merchants that sell merchandise both in conventional and online retail settings.

The network environment in which the presently described re-ordering and buying management system for specialty retailers operates is described in FIG. 1. In FIG. 1, merchant platform 100 comprises processor 102 having an operating system that enables executable code or software to control various modules including a point of sale interface generator 104, and purchase order generator 114. Management platform 100 further comprises various data stores including inventory data store 106, customer data store 108 and order data store 110. A user interface 114 provides an administrator with a display means or terminal to input instructions or otherwise customize the functionality of management platform 100. Inventory data store 106 contains data concerning units of items according to vendor, style, size and color on hand, as well as receipt dates narrowed down to each particular unit on a last received unit basis including the invoice number that the unit arrived on. Customer data store 108 includes various customer information collected by merchant clerks on point of sale devices 142 in the form of handheld units or the like. Customer information is also collected online by customers using devices such as smartphones 172 or personal computers 174 in communication with merchant platform 100 via a wide area network 180 such as the Internet. The various hardware and devices described communicate over wireless or wired communication channels according to various communication protocols known in the art. Smartphone 172 and/or computer 174 or other personal device has downloaded thereon a dedicated application program for the merchant, enabling exchanging information with the merchant before, during and after shopping at the brick and mortar location.

Point of sale devices 142 are equipped with a barcode scanner permitting employee users to process items for purchase. The barcode on an individual item uniquely identifies that item. Once a purchase is made, the various inventory related database information is updated to reflect the purchase and corresponding user interfaces concerning inventory and items on hand, as described below, are updated to reflect recent purchases.

Point of sale devices 142 has an associated processor and card reader to accept and process purchases made with credit, debit, gift cards and the like, through which such cards may be swiped, tapped or inserted, or the card information manually entered by the employee. A cash drawer is associated with point of sale device 142 for acceptance of cash payments. Point of sale device 142 also interfaces with a printer to print hard receipts for recordkeeping of the customer or merchant as desired. Point of sale device 142 also includes means to scan MICR code information on checks presented by customers to pay for items, allowing the merchant to determine whether the customer has adequate funds to cover the check, communicating with the merchant's bank or third party check processing vendor.

Artificial intelligence (AI) software module 190 is associated with processor 102. AI module 180 leverages various data collected by the presently described merchant re-ordering and buying management system during point of sale transactions, inventory management operations, purchase order creation and updating and employee management capabilities to provide the merchant with valuable ordering, inventory management, style management, advertising and customer relations information and employee management information.

One or more application programs are stored in application program data store 107 and are accessed by processor 102 and executed to perform the various functionality and operations of re-ordering and buying management system as described herein. Applications programs include but are not limited to report generation application program 192, purchase order generation application program 112 and graphical user interface generation program 194. The various application programs create the various reports, screens and interfaces described herein according to user selections via the graphical user interface as will be described.

Customer information includes customer name, phone number, email address, physical address, customer type, purchase and order history including last sale date and wear date, the assisting retailer employee, return history, size information, notes and the like. Customer information is retrieved at future visits to the merchant's brick and mortar or virtual retail location by entry of unique identification information, such as a phone number, email address or other unique customer number. Customer purchases, orders, returns and other information is tied to the customer data stored in customer data store 108.

Order data store 110 contains order data on an item by item basis according to vendor and tied to a particular customer identifier. Order data comprises dates of the order, date of order completion, product price, purchase order, and cost. Reports data store 111 includes customizable reports generated by the merchant, drawing data from the other data stores. Reports can be generated for all historical sales based on a customer, vendor, product style, color, size, location or the like, or based on a merchant defined data range. Employee data store 113 includes information associated with an employee of the merchant and is used to store payroll information, employee work schedules, employee productivity and profitability metrics and commissions owed employees stemming from product sales.

Note that storage of the various data and application programs and associated hardware herein described is at a single storage medium or several co-located storage mediums at one location including the merchant location. Alternatively, data and programs are stored over a distributed network, such as via the “cloud” or other remotely located data storage facilities.

Merchant platform 100 communicates with vendor server 120 over network 180 or other suitable network to send to and receive from the vendor information. For example, vendor server 120 has an associated product information store 122 that includes all products and associated attributes associated with that vendor. Merchant platform receives new product offerings from a vendor via vendor server 120, enabling the merchant to offer new products to customers for order and sale.

A merchant enters customer information from customers and corresponding orders at merchant server 140 which is in communication with various merchant devices, including administrator terminal 114 and point of sale (POS) device 142. In one embodiment, the merchant at issue is a formalwear retailer such as the type that sells formal gowns for events such as weddings, balls, proms and the like. Such retail locations typically include many, many styles of formalwear in various sizes available for potential buyers to try on when making a purchasing decision. These retail outlets are often staffed with sales personnel equipped with POS devices 142. These POS devices 142 are used to enter new customer information such as the type discussed in connection whit customer data store 110 upon arrival at the brick-and-mortar establishment. For returning customers, sales personnel can easily retrieve the customer file based on the customer's unique phone number, email address or other indicator. POS device 142 retrieves existing customer profile data via the customer data store 110 on the merchant platform and is presented with a graphical user interface for input of new customer information. For existing customers, sales personnel create a new visit ticket containing details and attributes of the customer's current visit, order details and the like.

Merchant platform 100 also receives customer information via remote users visiting the merchant's online marketplace. The merchant's social media presence via social media outlets 176 are accessed over the internet 180 by the user, to which articles for sale are linked. The user accesses the social media links 176 via smartphone 172, personal computer 174 or other personal digital device. The user may also access the merchant's online store directly via these devices over network 180 and log into the merchant's site in order to obtain his or her account.

Merchant platform in one embodiment also communicates over network 180 to shipping platform 160. Shipping platform 160 generates shipping labels for orders placed and items received by the merchant that is ready to be shipped to the user. A merchant typically has an account with shipping platform 160 preventing the merchant from re-entering standard information common to each order and allows the merchant to retrieve information from past shipments and orders to make the shipping process more efficient.

The presently described re-ordering and buying management system is a technical improvement over the prior art and significantly more than automation of ordered processes at least in providing merchant users a single interface platform via a computer device, whether a point-of-sale device or backroom or remote device, for inventory management, product ordering, customer account management, notification generation, employee management and report generation of one or multiple categories of data. Prior art systems that entail users visiting or accessing multiple platforms, both of the merchant and third parties via multiple software application prove cumbersome, particularly when data is needed by merchants at the point of sale. The point-of-sale order and inventory management system offers a significant technical advance by availing merchants of a wide array of data processing and report generation capability via a point of sale terminal that traditionally is a device that simply processes customer payment.

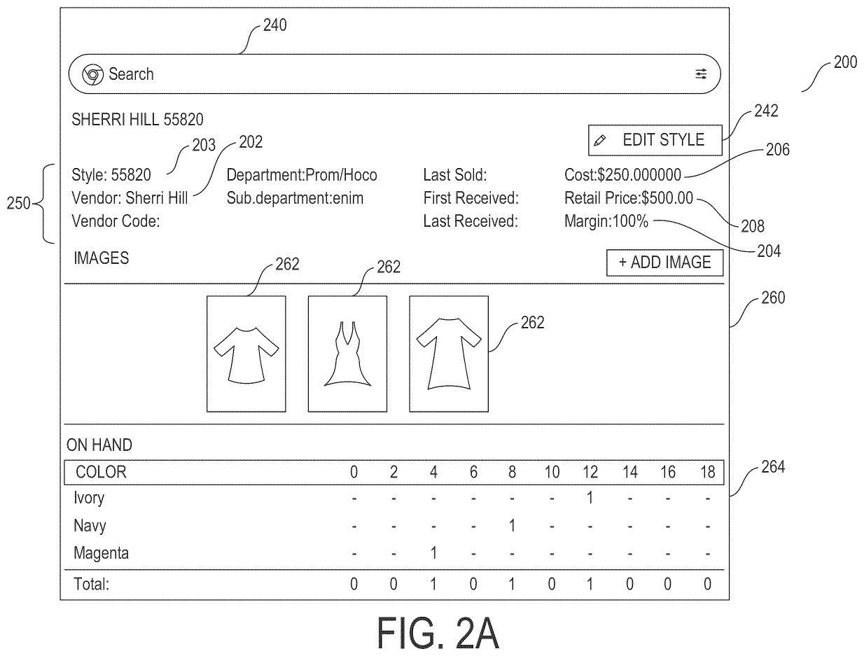

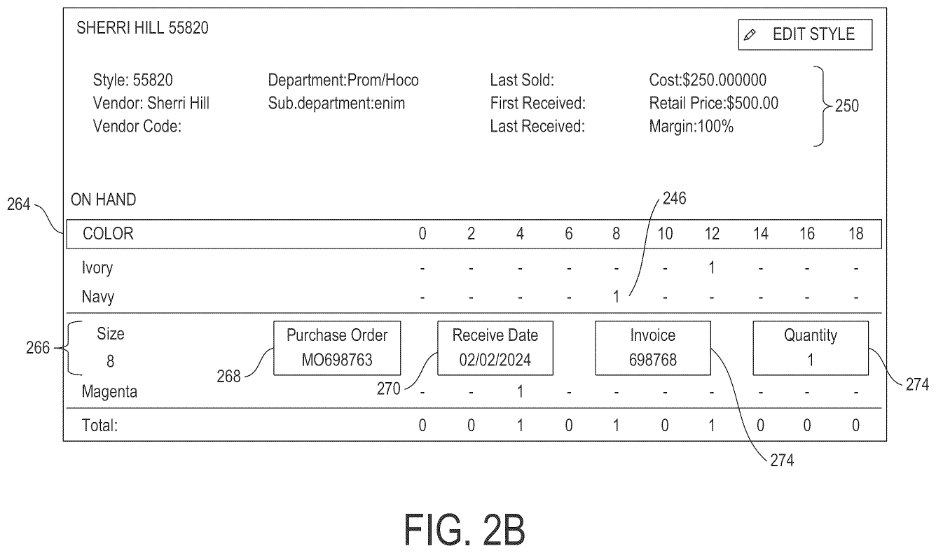

FIG. 2A depicts a merchant order tracking screen of a merchant re-ordering and buying management system according to an embodiment. Merchant order tracking screen 200 includes style information section 240 containing various fields for manual entry of information via a user interface generated by merchant platform 100. In an embodiment, the merchant is a women's formalwear retailer. The tracking screen shown includes vendor field 202, style number field 203, margin field 204, cost field 206 and retail price field 208. Other information provided on tracking screen 200 includes a vendor code field, a department field and subdepartment field, a last sold date field, a first received date field and a last received date field. Tracking screen 200 also includes search bar 240 in which the user enters a desired product to track. In an embodiment a user enters a designer name or a style number as the search term. In the example of FIG. 2A, the vendor is formal wear designer Sherri Hill, the style number is 55820, the product cost is $250 and the retail price is $500 and the margin is one hundred percent, as shown in the respective fields of tracking screen 200. The various fields described reside in style information section 250 of merchant order tracking screen 200. Edit style activation button 242, when selected, prompts the user to a screen to edit the various underlying data associated with the vendor product and style at issue. Once the edit button is selected, the user is presented with a pop-up screen that enables the user to delete, modify or add values or information corresponding to the various information fields within style information section 250.

Beneath style information section 250 in one embodiment is images field 260. Images field 260 includes various images and views 262 of the particular garment that is the subject of a particular merchant order tracking screen 200. Images field 260 depicts various colors available of the garment in the particular style or other imagery associated with the garment.

The user interface for merchant order tracking screen 200 generated by the presently described merchant platform allows the user to scroll down to view and modify various data associated with the garment while the header sections being the style information section, images field and search bar 240 remain viewable to the user while scrolling.

In this “single style” view, as the user scrolls down to other information associated with the selected garment style, known graphical user interface techniques for screen scrolling and manipulation are employed. As the user scrolls, in one embodiment on hand table 264 is presented to the user.

On hand table 264 presents data according to the number of items on hand and on order. On hand table 264 presents in units the number of garments in the same subject style that are on hand at the retailer (that is, available for sale) according to garment color and size. In one embodiment, on hand table 264 is presented as a matrix of garment color and size. As shown in FIG. 2A, three units of style 55820 of this vendor are on hand. In particular, on hand table 264 depicts that one magenta unit in size four, one navy unit in size eight and one ivory unit in size twelve are on hand. Note that merchant order tracking screen 200 is presented in single style format. Optionally, the user may designate that data associated with multiple styles be displayed on a single screen, in split or divided screen format, allowing the user to view many styles in parallel.

Throughout the various user screens and interfaces as will be discussed, information is presented in different formats and within different contexts, such as single item views, purchase order listings, on hand and on order listings, full inventory listings, purchase order summaries and the like. Such information and formatting include dates of various orders fields, item color and various size fields. These fields are used to identify the dates on which various colors of a particular garment style were ordered and in which color. Sales dates fields and purchase order fields are also presented. That is, the specific customer purchase order field includes the purchase order that corresponds to the other information in the fields occupying that column. For example, on a particular date, one size 00, one size 2 and one size 4 bright blue or “brt blue” garment may have been ordered and on a future date, the order of those garments was filled via purchase order ROxxxxx, as entered in a dedicated purchase order filed.

When viewing on hand table, the user may retrieve more granular data associated with the various “on hand” items. FIG. 2B depicts an on hand table of a re-order and buying management system according to an embodiment. On hand table 264 is depicted after selection of a particular number of units on hand of a garment of a certain size and color. Various items in on hand table 264 are selectable by the user to retrieve the more detailed data. In an embodiment, the displayed number of units on hand of a garment of a specific size and color are displayed as one or more selectable unit links 265. As shown, the number “1”, indicating there is one unit in navy in size eight of garment style 55820 is selectable by the user. When the user selects selectable unit link 265, on hand table 264 expands to provide the user with more information.

As shown in FIG. 2B, upon user selection of selectable unit link 265, on hand table 264 expands to provide the user with detailed information associated with the one unit on hand of the navy garment in size eight. Expanded on hand field 266 provides purchase order field 268, indicating the purchase order number for that unit, receive date field 270, indicating the date the unit was received, vendor invoice field 272, indicating the vendor's invoice number and quantity field 274, indicating the number of units associated with that purchase order. A similar operation may be performed by the user to obtain detailed data for the other units on hand for the style of garment at issue. Note that throughout the operation retrieving expanded on hand data, style information section 250 remains as a header on the user interface, permitting the user to keep track of the garment style and associated vendor. In addition, the total number of units of per size on hand for each garment is provided at the bottom of on hand table 264, whether on hand table 264 is expanded or not.

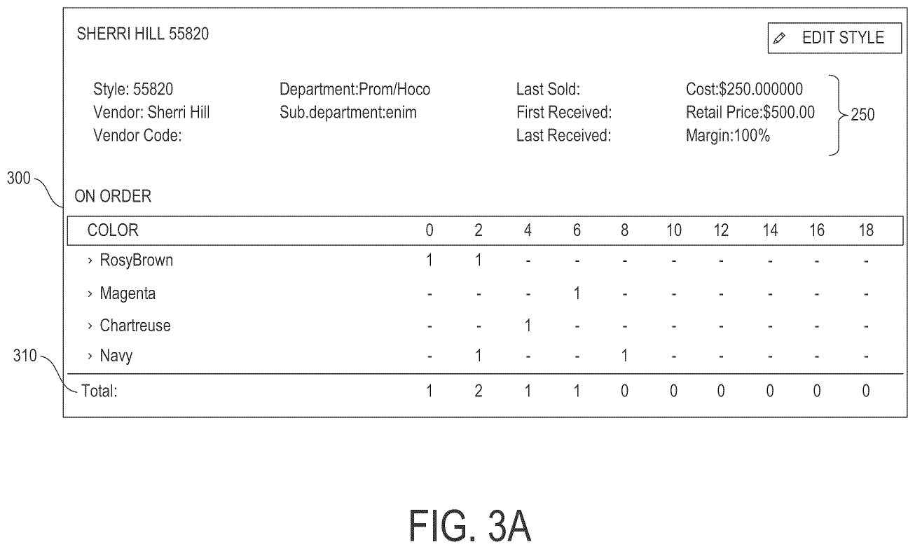

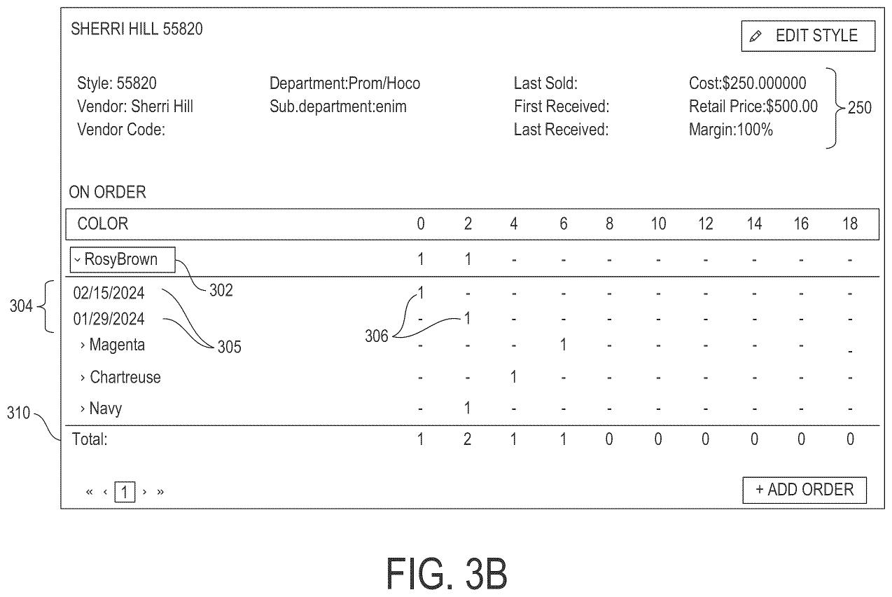

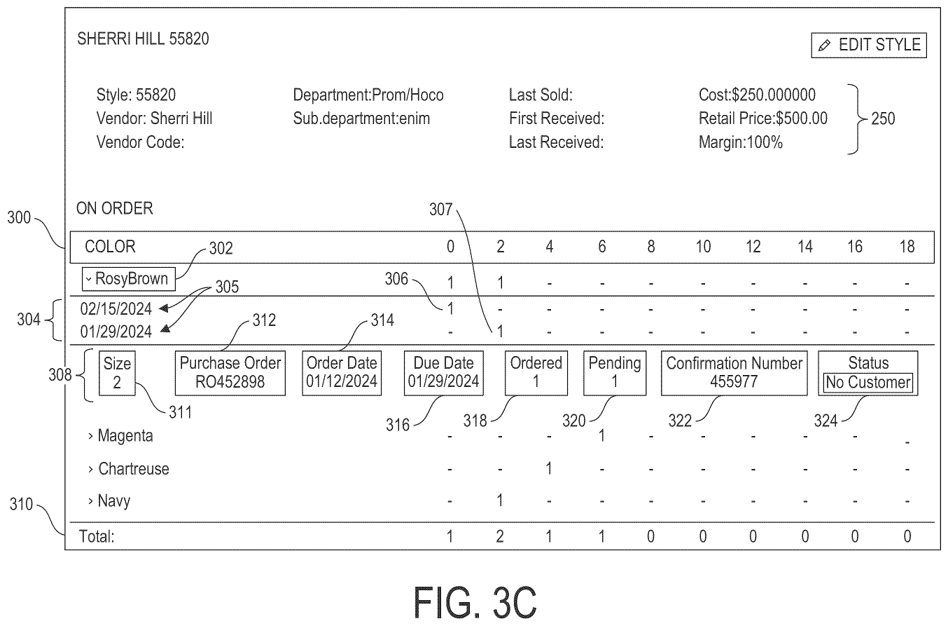

FIG. 3A depicts on order table of a re-order and buying management system according to an embodiment. On order table 300 is displayed as the user scrolls further down past on hand table 264 of merchant order tracking screen 200 for the selected garment style of a vendor according to an embodiment. Note that style information section 250 continues to be viewable as the user moves from on hand table 264 to on order table 300. On order table 30 in an embodiment depicts a matrix of the number of units of each garment color in each size that are on order. The bottom of on order table includes on order total field 310 in units of each size of that garment.

In order table 300 as shown in FIG. 3B, color field 302 is selectable by the user to invoke drop down table 304 according to the color field selected. As shown in FIG. 3B, selection of color rosy brown in color field 302 results in drop down table 304 appearing with expected deliver dates 305 and corresponding on order unit numbers 306 associated with those order dates. As shown, one unit of the subject style in rosy brown color in size zero was ordered Feb. 15, 2024 and one unit in size two of that color was ordered Jan. 29, 2024. Again, while selecting more detailed data concerning on order status, style information section 250 remains as a header on the user interface, permitting the user to keep track of the garment style and associated vendor.

FIG. 3C depicts an on order screen of re-ordering and buying management system for specialty retailers according to an embodiment.

In FIG. 3C, the units displayed within drop down table 304 are selectable by the user. As shown, the one unit of size two of the subject garment in rosy brown is selectable via on order unit selectable link 307. Upon selection of on order unit selectable link 307, order status drop down table 308 is presented to the user. Order status drop down table includes size field 311, purchase order field 312, order date field 314, due date field 316, units ordered field 318, units pending field 320 confirmation number field 322 and status field 324. Purchase order field 312 includes the purchase order number for the unit selected via order unit selectable link 307. Order date field 314 indicates the date the subject unit was ordered. Due date field 316 indicates the date that delivery of the order is due to be delivered to the merchant. Ordered field 318 indicates how many units were ordered and pending field 320 indicates how many have yet to be delivered. Confirmation number field 322 includes the vendor provided confirmation number for the order and status field 324 indicates whether the order is pending, meaning the item has not yet been delivered, or past complete, indicating that the item due date has passed. If the item has been delivered, it no longer appears as “on order”. Once an item is delivered, the user may select the status button or activate the appropriate field via the computer pointer device (such as a mouse or stylus) and enter the appropriate received date and invoice number. This action moves the item from “on order” to “on hand”. If the status is past complete, the merchant may send a query to the vendor regarding the status of the order, cancelling the order, etc.

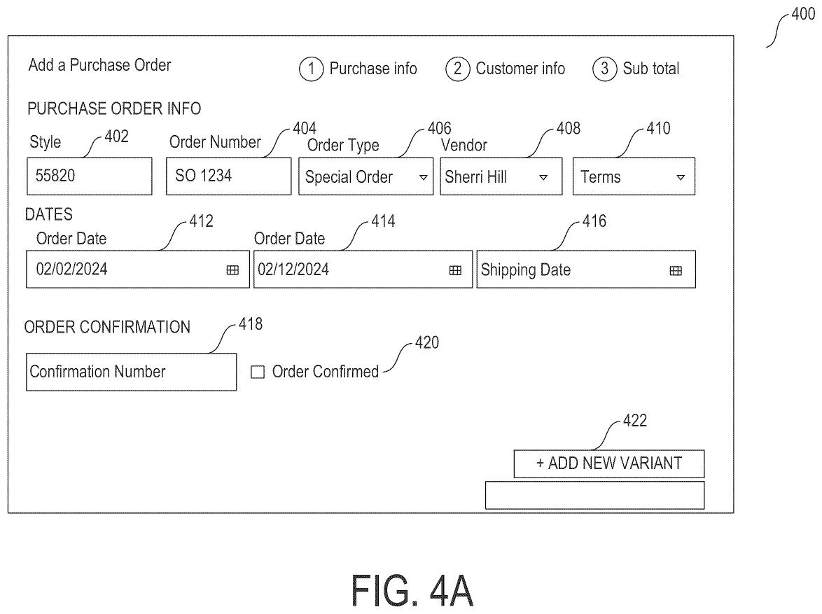

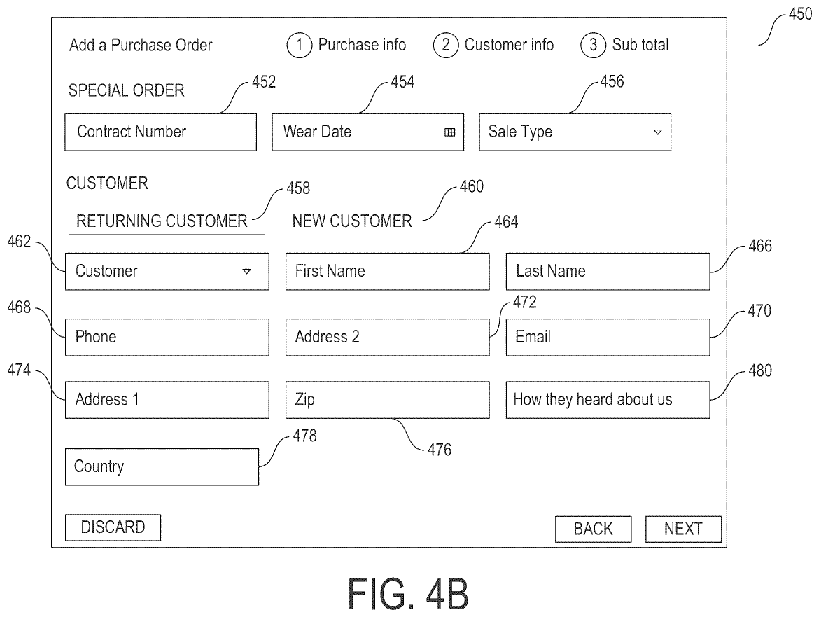

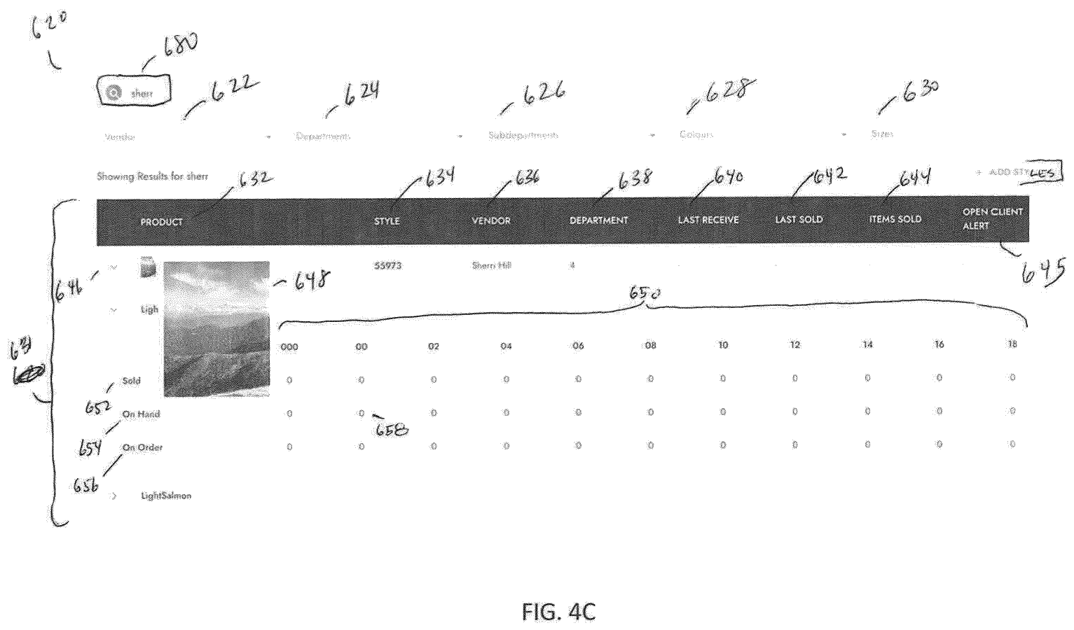

New purchase orders are entered by the user according to units ordered of garments of a particular vendor and styles. FIG. 4A depicts a purchase order interface of a re-order and buying management system according to an embodiment. A purchase order interface for the user to add a purchase order to merchant order tracking screen 200 according to an embodiment is provided. As shown in FIG. 4A, once a user invokes an “add order” command on merchant order tracking screen 200, add purchase order interface 400 is presented to the user via the display associated with the user's device. Through this interface, the merchant vendor user inputs information concerning new units ordered via add purchase order interface 400. Add purchase order interface 400 includes several fields into which the user inputs various information concerning the new order. These fields include style field 402, order number field 404, order type field 406, vendor field 408, terms field 410, order date field 412, due date field 414, shipping date field 416 and order confirmation number field 418. Add purchase order interface 400 also includes order confirmed box 420 that is checked off once an order confirmation number is received and populating order confirmation number field 418 with a number is permitted. Add purchase order interface 400 in an embodiment also includes add new variant key 422. User selection of add new variant key 422 permits the user to add additional parameters to the purchase order information that are selected from a predefined list or optionally are manually added by the user. Adding a new variant through the interface permits the user to add a variant not previously entered without having to inconveniently exit from one interface and add the variant elsewhere. Through this feature the user adds a new color, size or style directly from the purchase order interface. Once the variant is added, it will appear in the various drip down menus for that variant category.

In an embodiment, if the “add order” command is invoked while the user is in single style mode of merchant tracking order screen 200, then style field 402 and vendor field 408 are prepopulated with the style number and vendor name or code that applies to the subject garment style. Alternatively, the user may enter a different style number and vendor name if applicable.

Order type field 406 refers to the type of order, including special orders, which in the example is designated by the code “SO”. A special order concerns a merchant customer placing an order for an item that will not be placed in the merchant's “on hand” inventory or category, meaning that this specially ordered item will not be treated as a unit that a customer may purchase in person or online as an “off the rack” item. Instead, special order items are reserved for the ordering customer. Despite this, overall inventory of the merchant includes special order items, as will be discussed.

Continuing with the add purchase order interface 400, order type field 406 refers to the type of order. As discussed above orders may be special orders or standard orders of units that are available to customers as part of on hand inventory. Terms field 410 refers to the terms between the merchant and the vendor for the order. As shown, the order type is a special order and, accordingly, the customer may have made a ten percent deposit. From this interface the user continues on to “customer information” as the purchase order is tied to the particular customer. The various selections for order type field 406, vendor field 408 and terms field 410 are available via drop down selections or, alternatively, other values may be entered by the user.

The dates fields 412, 414 and 416 of add purchase order interface 400 refer to the date on which the order was made, the date on which the order is due to the customer, and the anticipated shipping date of the item, respectively. Each of date fields 412, 414 and 416 include a selectable calendar from which the user selects the relevant date from a calendar representation, which is modifiable by month and year. Add purchase order interface 400 further includes order confirmation number, which is fillable once the user selects or checks order confirmed box 420, at which point the user enters a received confirmation number from the vendor.

Once add purchase order interface 400 is populated for the new purchase order, a add purchase order customer interface 450 is presented to the user as shown in FIG. 4B. FIG. 4B depicts an add purchase order interface of a re-ordering and buying management system according to an embodiment. Add purchase order customer interface 450 includes several fields for user entry of customer information. Note that item at issue in add purchase order customer interface 450 is identified as a “special order” by virtue of entry of special order as the order type in order type field 406 of add purchase order interface 400. The various fields of add purchase order customer interface 450 include contract number field 452, wear date field 454, sale type field 456, customer menu 462, customer first name field 464, customer last name field 466, customer phone number field 468, email field 470, customer address fields 472 and 474, customer zip code field 476, customer country 478 and customer source field 480.

Add purchase order interface 400 further includes returning customer tab 458 and new customer tab 460. If the customer to which the newly entered purchase order applies is an existing customer, the user selects returning customer tab 458. Then, a dropdown menu of existing customers is presented. Optionally, the user uses the search bar to search for customer data, such as search bar 240 of FIG. 2A, which is present on the various user interfaces described. The user's selection of an existing customer will pre-populate the various fields pertaining to the customer's information. If, on the other hand, the customer is a new customer, then the user manually populates the various customer information fields.

Contract number field 452 is used to input the contract number of the customer's order. Wear date field 454 is used to input the date when the customer intends to wear the garment. Sale type field 456 includes the type of sale that occurred, including on online or in store sale and can also include a layaway sale, selectable via dropdown menu. Customer menu 462 is invoked when returning customer tab 458 is selected. As discussed, if returning customer tab 458 is selected, then existing customer names are presented in dropdown menu form in customer menu 462 (or via entry of a name in the search bar), from which the customer selects an existing customer. Upon doing so, the various customer information fields are automatically populated based on previously stored customer information.

If the customer is a new customer, new customer tab 460 is selected and customer first name field 464, customer last name field 466, customer phone number field 468, email field 470, customer address fields 472 and 474, customer zip code field 476, customer country 478 and customer source field 480 are manually populated with the relevant information Customer source field 480 refers to the manner in which the customer learned of the merchant.

Once entry of the information on add purchase order interface 400 and add purchase order customer interface 450 is complete, the item order via this purchase order will be added to the item on order screen 300 as previously described in connection with FIG. 3A. Through the merchant order tracking screen 200, the merchant user is able to determine either globally, on a style by style or item by item basis according to size and/or color the number of units that are on order, the status of the order, and the underlying customer information for that order.

FIG. 4C depicts re-order interface of a re-ordering and buying management system for specialty retailers according to an embodiment. Re-order interface 620 is for the retailer re-ordering of items based on various item parameters. Interface 620 includes a number of drop down menu options and selectable data entries. Re-order interface 620 comprises vendor drop down menu 622 from which various pre-stored vendors are selectable. Departments drop down menu 624 and subdepartments drop down menu 626 list selectable departments and subdepartments, respectively, that the user may select that pertain to the particular items that are to be re-ordered. These are filtering options from which the user filters for a specific date range, vendor, department, sub-department, color, size or any or all of these categories simultaneously to view the data for the resulting styles. The user is then able to move through the styles as if flipping through pages of a book. Color drop down menu 628 and sizes drop down menu 630 pertain to the color and size of the item to be re-ordered, respectively. Re-order results field 631 displays information pertaining to the search term entered in search bar 680. As shown, the term “sherr” is entered, resulting in display of results for vendor “Sherri Hill”. Rather than using the search bar, the user may make selections from the various drop down menus discussed, the selections of which will populate re-order results field 631, as through a filtering process as discussed. The user may further search within the filtered data according to the various parameters selected by searching for a particular attribute via the search bar or by viewing the data on a style-by-style basis.

As shown, re-order results field 631 includes various items of information, including product image drop down 632, product style 634, product vendor 636, product department 638, product last received date 640, product last sold date 642, number of items sold 644, and number of open client alerts 645. User activation of product image drop down 632 causes expanded image 648 of the item of interest to appear on the user interface. This provides the user with visual confirmation of the item under consideration for re-ordering.

Continuing, re-order results field 631 includes sizes row 650 that includes the range of sizes available for items, in this case garments, for the particular vendor (Sherri Hill) in a particular style (55973). Re-order results field 631 also includes sold quantity 652, on hand quantity 654 and on order quantity 656. These quantities data points and sizes row 650 result in a table of various item quantities 658 displayed in re-order results field that correspond to the number of units sold during a specific period, units on hand currently (not period specific) and units on order (not period specific) with respective delivery dates, purchase orders, date ordered and other information as shown in FIG. 3B and FIG. 3C for a particular item style of a particular size for a particular color. In this example, the color is light blue which is obscured in the figure by expanded image 648. Another color, light salmon, is shown beneath on hand quantity 654 for the light blue item. Upon user selection of the drop down for light salmon, another matrix of items sold, on hand and on order by each size will be presented to the user for light salmon. Through re-order interface 620, the user selects various units in the matrix, which are selectable links, for re-ordering of a quantity of a vendor item, of a certain style, color and size while in the same interface being presented with the various data points such as when the item was last received, last sold, how many were sold, etc.

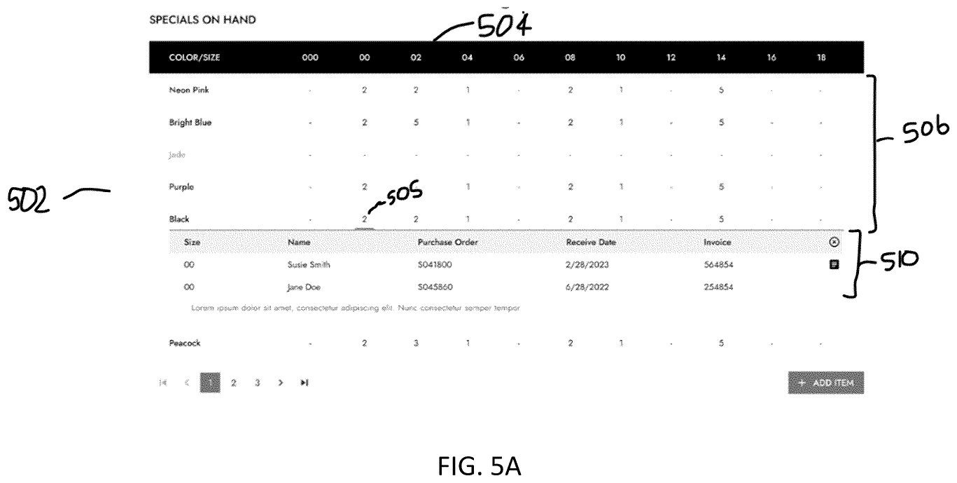

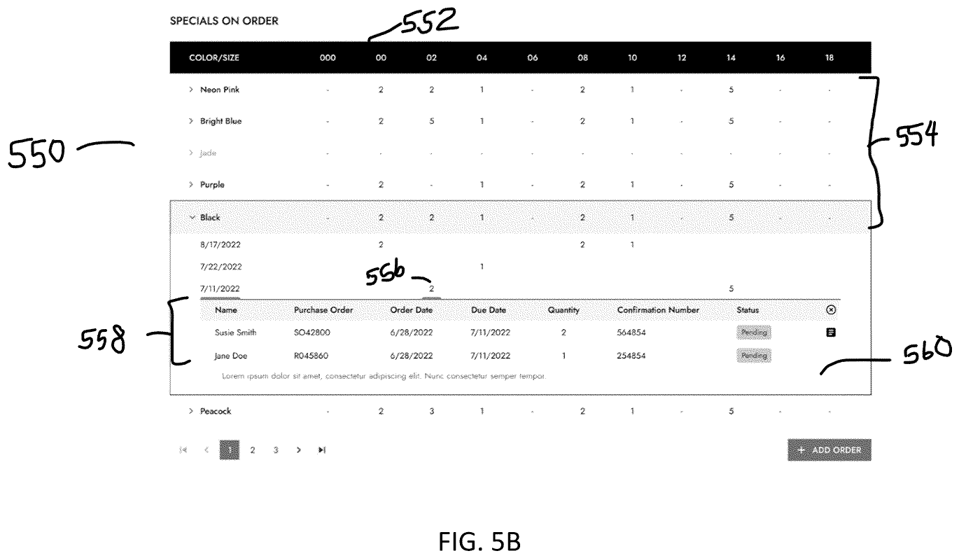

Similarly, on hand table 264, as depicted in FIG. 4B reflects the item subject to a newly added purchase order once the item is received by the merchant. Note that on hand table 264 and on order screen 300 are distinguished from specials on hand table 502 and specials on order table 550 as shown in FIG. 5A. FIG. 5A depicts a specials on hand interface of a re-ordering and buying management system for specialty retailers according to an embodiment. FIG. 5B depicts a specials on order table interface of a re-ordering and buying management system for specialty retailers according to an embodiment.

In the specials on order interface of FIG. 5A, a purchase order stemming from a special order item, once made, will be listed in in specials on order table 502 rather than general on order screen 300. Similarly, a special purchase order, once received by the merchant, will be listed among the special on hand items in special on hand interface 550 as depicted in FIG. 5B rather than on the general on hand table 264. This is because when the specially ordered product arrives at the store, it is separated from regular or off the rack on hand items that are available for purchase by any customer. Keeping specially ordered goods off of the general on hand table 264 and the general on order screen 300 prevents merchant employees from mistakenly believing that more units available for general purchase are either on their way to the store, or already on hand. This way, customers do not find themselves angry or disappointed when they are told that the store will or does have more units for sale than it actually does. Items received by special order are just that, specially ordered for the specific ordering customer.

Special order data is viewable by the user, in one embodiment, by user selection of a particular quantity number within a special order table, with the quantity number acting as a link. A quantity for an item of a particular color and size ordered on a certain date is enabled as a selectable link that when selected invokes display of detailed information for that order in a first detail pop up. First detail pop up provides the purchaser name, the purchase order number and the order completion date. A second detail pop up is provided for an item of the same or different color in a different size. When the quantity, such as “2” is selected, a second detail pop up is displayed. This second detail pop up provides the purchaser name for each unit, the purchase order number, the date the order was received and the invoice number. If the pop up does not include the completion date, meaning the item is still “on order”. In other embodiments, other data may be included in the pop up according to the merchant's needs. The methods of information display and the underlying content collected and displayed is fully customizable and the embodiments depicted and described herein are not to be treated as limiting of the capabilities of the presently described re-ordering and buying management system re-ordering and buying management system.

As shown in FIG. 5A, specials on hand interface 502 in an embodiment includes a color and size matrix 506 that includes a size row 504 on the horizontal axis of the matrix and a color column on the vertical axis of the matrix, as shown. Quantity link 505 is the quantity of units of a particular item in a certain size and a certain color, represented by its placement on color and size matrix 506. As shown, quantity link 505 indicates that there are two units on hand, that are special order units, in the relevant item in the color black and in size 00. Upon user activation of quantity link 505 (via a computer mouse, a stylus, a finger (for touchscreen devices) or other suitable selection device), the user is presented with more granular information for the two units as shown in quantity link detail field 510. Quantity link detail field 510 for a special on hand item depicts various detailed data concerning the units at issue. This data includes the size of units, the name of the customer who specially ordered the unit or units, the purchase order number associated with each unit, the receive date for each unit and the invoice number associated with each unit. As discussed, special items are included in specials on hand data and interfaces and not general on hand data and interfaces. This is to prevent retailer employees from incorrectly believing that specially items are generally available for sale.

FIG. 5B depicts a specials on order interface of a re-ordering and buying management system for specialty retailers according to an embodiment. In FIG. 5B, specials, referring to specially ordered or special order items, are displayed in specials on order interface 550. Specials on order interface 550 includes specials on order matrix 554 that includes on a by unit basis the number of units on order for specially ordered items for a style of an item according to color and size. As shown, specials on order matrix 554 includes specials on order size row 552 that is the horizontal axis of specials on order matrix 554 and a column of colors is the vertical axis. As shown in specials on order matrix 554, numbers representing the number of units on order for an item of vendor of a particular style are presented corresponding to the color and size of that item. As shown in FIG. 5B there are units on order of specially ordered items of many color and style combinations.

In FIG. 5B, the column of colors of specials on order matrix 554 are presented as drop down items. In FIG. 5B, the drop down of the black item is activated, resulting in more details of the specials items on order that are in the color black. In the drop down, more detailed rows concerning the specials items on order in black in various sizes. In FIG. 5B, the due dates on which the individually ordered items in black are shown. Within this drop down, the specials on order unit link 556 is shown, here for the number of units on order for black in size 02 that are due Jul. 11, 2022. Specials on order unit link 556 is selectable by the user in the methods described (mouse, stylus, finger, etc.). Selection of specials on order unit link 556 results in presentation of even more detail concerning, in this example, the two specially ordered units for this style item in black in size 02. For the two units specials on order details table 558 is presented upon user selection of specials on order unit link 556. As shown, for the two units in black in size 02, the name of the customer who placed the order, the purchase order number, the order date, the due date, the quantity of the special order items, the order confirmation number and the status are shown. Note that optionally the regular units of this item on order are also displayed. Once the on order specials item shown on the on specials on order interface of FIG. 5B is delivered, it appears on specials on hand interface of FIG. 5A. Once a specialty item moves to specials on hand interface 5A, the invoice number is provided, representing completion of the delivery.

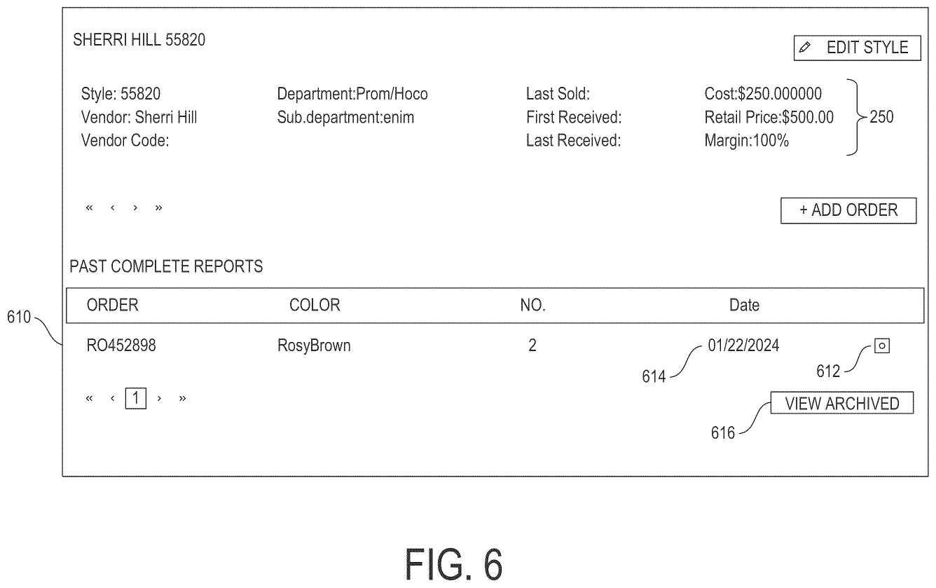

FIG. 6 depicts a past complete report screen according to an embodiment. As shown, when the merchant user continues to scroll down with the original merchant order tracking screen 200 header that includes style information section 250 remains visible to the user. Past complete report table 610 is displayed to the user via user interface generated by merchant platform 100. Past complete report table 610 includes those orders that have not been delivered by the anticipated delivery date. That is, the product that is subject continually visible as the user scrolls down among the many informational screens and tables as described. Past complete report 610 table includes various fields containing information such as an order number, a item color, a size, and the expected delivery date 614. Past complete report table further includes icon 612 that when shown indicates that there are deliveries that are currently past due. A user also views archives by activating view archive key 616. This presents the user with previous past compete reports on goods that may have ultimately been delivered or were canceled. The archives allow the merchant to view negative trends or patterns indicative of delivery issues with a particular vendor or with particular clothing styles, colors, sizes or the like.

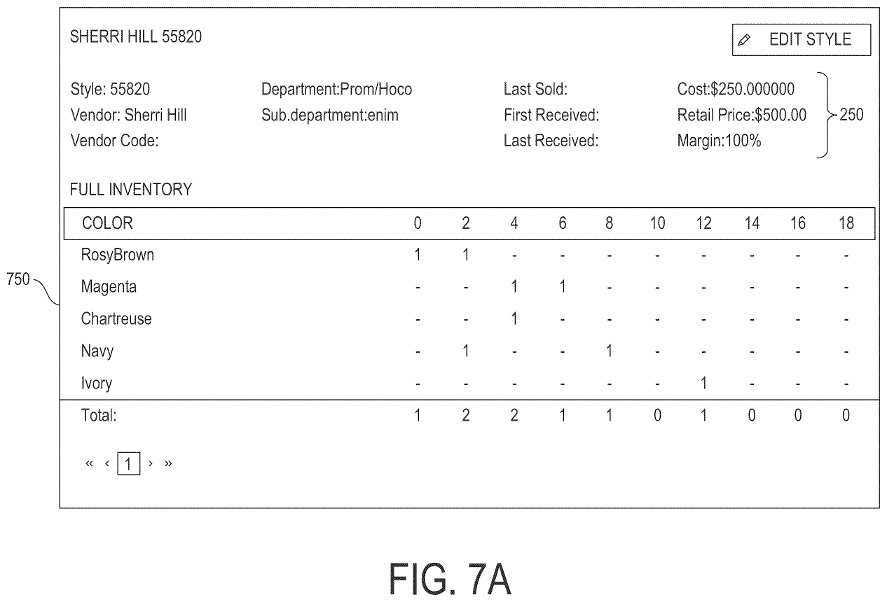

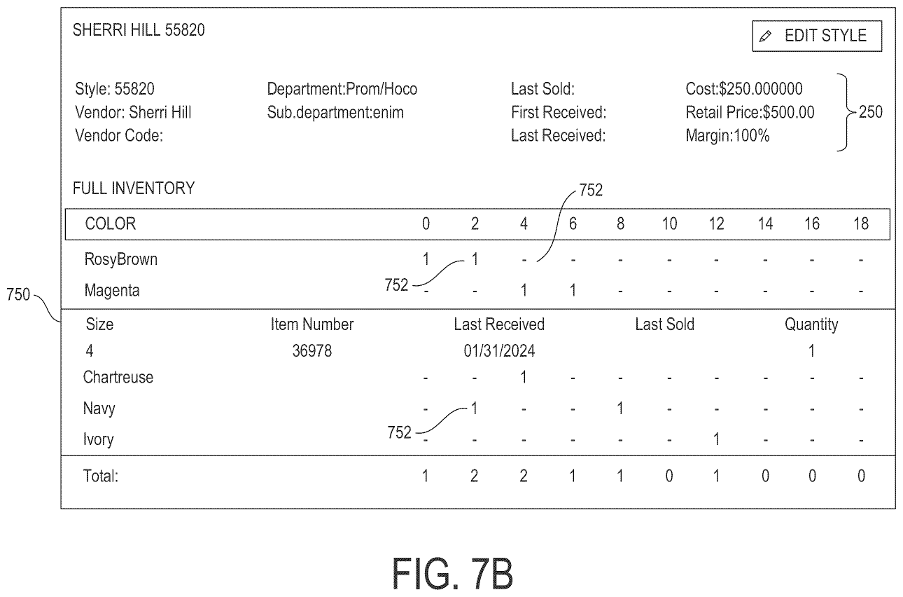

Continuing, FIGS. 7A and 7B depict a full inventory screen of are-ordering and buying management system for specialty retailers according to an embodiment. Like other screens described, in FIG. 7A full inventor screen 750 is viewed by the user while style information section 250 remains visible. Full inventory screen 750 includes selectable values 752 corresponding to the number of units of an item of a certain size in a certain color. In an embodiment, all units represented on full inventory screen 750 are selectable by the user. Upon selection, the user is provided with additional information concerning that item, such as the item number, the last received date, the date on which that type of item was last sold and the quantity in inventory, as shown in FIG. 7B. In single style mode, the inventory data concerning that subject style is displayed. Optionally, the user may select multiple styles or all styles from a single vendor or multiple vendors for display of inventory of those items corresponding to multiple styles and/or vendors.

Note that the quantity in full inventory screen 750 is an aggregation of the on hand and on order items as well as the special on hand and special on order items. Optionally, the user selectable filters one or more of the groups to narrow the inventory data presented, as desired.

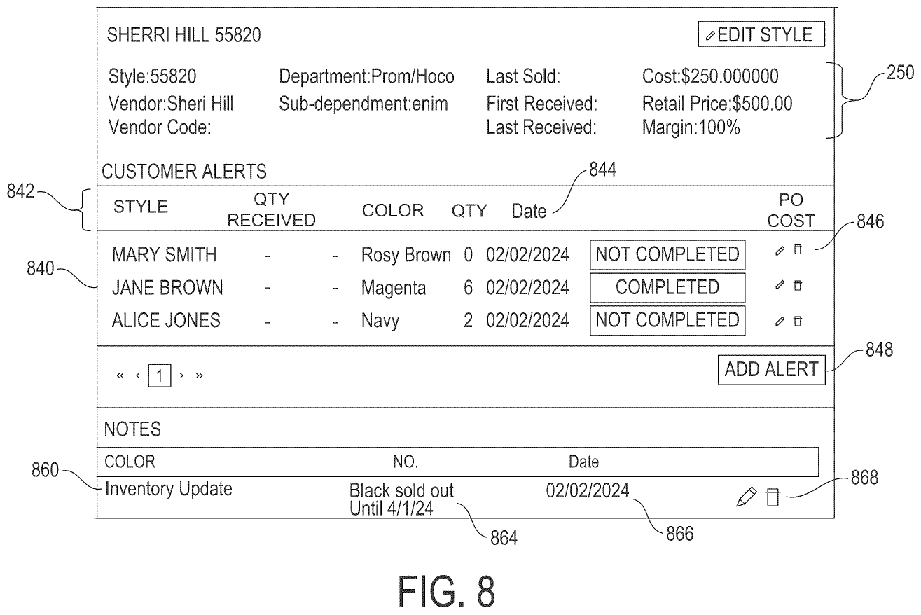

FIG. 8 depicts a customer alerts screen view generated by a re-ordering and buying management system for specialty retailers according to an embodiment. Customer alerts screen stems from various information gleaned from previous screens and tables of merchant order tracking screen 200. For example, a user sets up a customer alert based on an overdue or past complete report or a change in status of an order such as in transit or delivered. As shown, customer alert screen includes customer alert header 842 that includes information concerning the customer, such as the customer name, phone number, email address, item color, item size, anticipated delivery date and status field 844. As discussed with previous screens and tables, style information section 250 remains visible as the user scrolls down to customer alert screen 840, identifying the same style of interest. Through customer alert screen, the user is able to review the status of a particular customer's garment delivery, update the status of it, and add new alerts by selecting add alert key 848. The information for each customer alert can be edited or deleted via the edit and delete key for each customer alert. By editing, the user may revise the status of a customer alert from “not completed” to “completed” or change the due date based on new information received by the merchant from the vendor. Recall that customer information is input by the user when a purchase order is created. Among the customer information is the customer's email address. In an embodiment, when there is an addition to customer alert screen of a new alert for a particular customer, the customer receives an email or text message via the user's cell phone number concerning the particulars of the alert. Customer alerts are generated regardless of the level of a deposit made by the customer. Tracking numbers assigned to customer orders are optionally entered with the order data. The same holds true for changes in the status or due date of an item that was previously the subject of a customer alert.

Continuing with FIG. 8, in one embodiment, notes field 860 is reached by the user when continuing to scroll through the various screens and tables attributable to the same style that is the subject of merchant order tracking screen 200. Again, style information section 250 remains visible as the user scrolls down to notes field 860. As shown, notes screen includes text field 864, date field 866 and edit/delete keys 868. Typically, notes are for the merchant's internal use to give fast information about a particular garment. As shown in FIG. 8, the notes pertain to the same subject style depicted in style information section 250. In this example, text field 864 includes text pertaining to the garment in black is sold out until a date certain. Under text field, the date that the note was made is input by the user. The note is edited through edit/delete keys 868 if the status of the garment changes. Or the note is deleted through selection of edit/delete keys 868 if the note is no longer relevant.

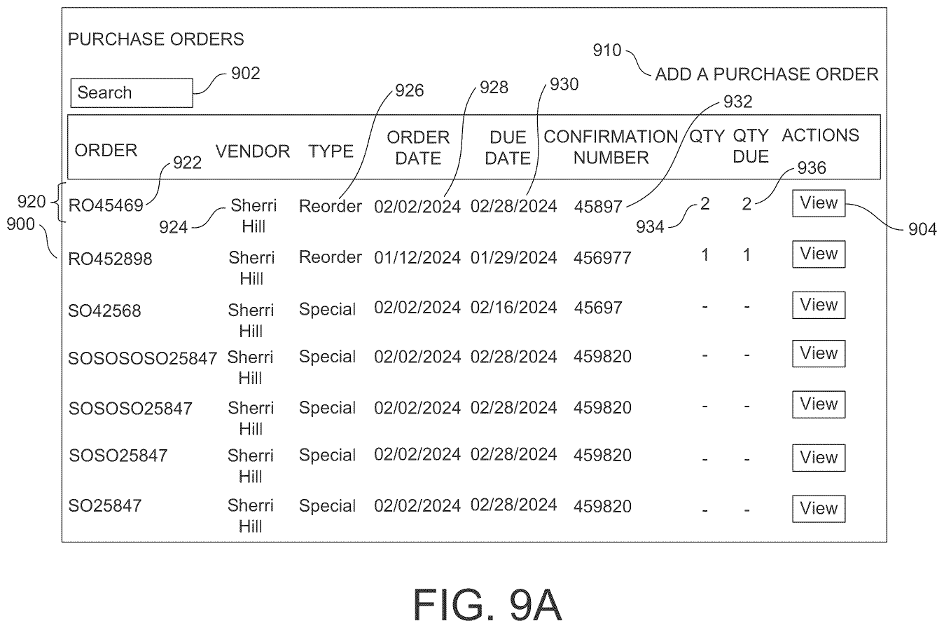

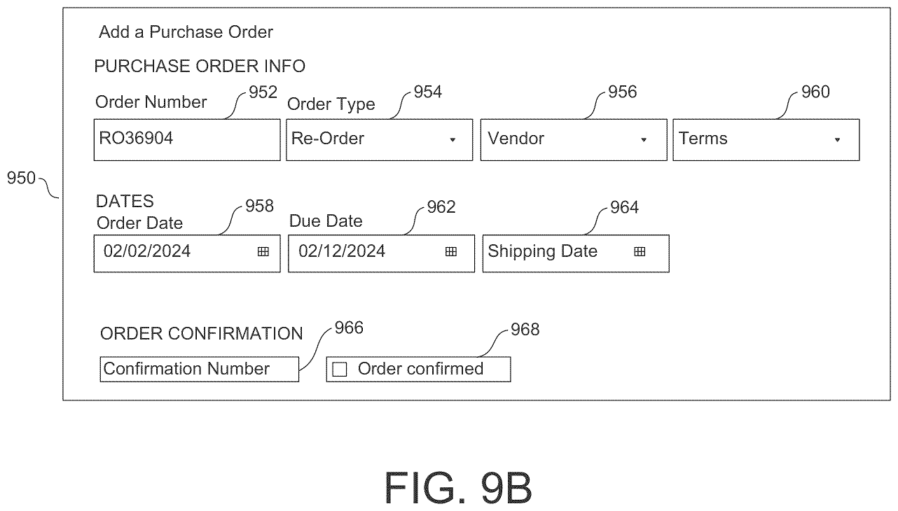

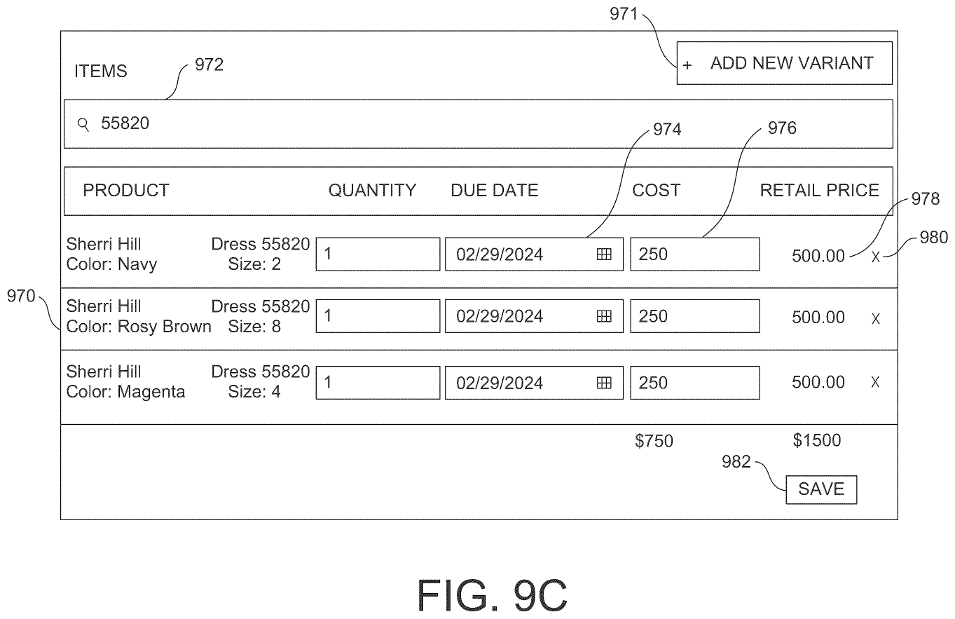

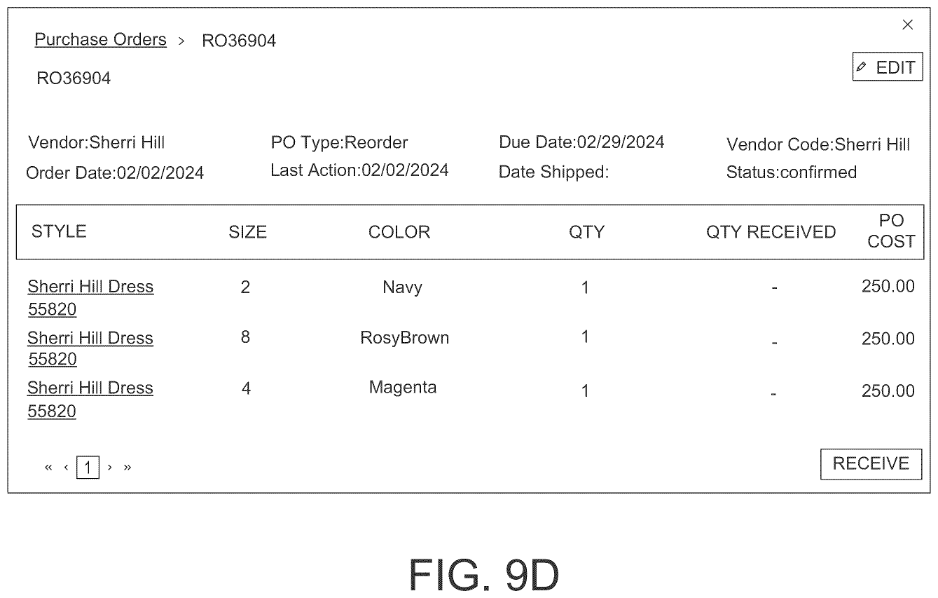

FIG. 9A depicts a purchase order screen according to an embodiment. Purchase order screen 900 in an embodiment is a global listing of purchase orders that is searchable by particular vendor, style, type of order, confirmation number, etc. The information in purchase order screen 900 is searchable by user input of various search terms in search bar 902. As shown, purchase order screen provides information concerning purchase orders according to order number, vendor, order type, order date, item due date, order confirmation number, item quantity and quantity due. Purchase order screen 900 further includes view key 904 that the user selects to retrieve more detailed information concerning that order.

Purchase order screen 900 includes order line 920 that includes various items of data concerning an order, including order number 922, vendor name 924, order type 926, order date 928, order due date 930, confirmation number 932, item quantity 934 and item quantity due 936. As shown, multiple order lines 920 are presented to the user via purchase order screen 900. Purchase order screen includes both re-orders and special orders, as denoted by the “RO” or “SO” prefix of the order numbers in the order number 922 column. Order type 926 information also refers to the type of order, whether a special order or a re-order.

Add purchase order button 910 causes the user to be presented with add purchase order interface 950 as shown in FIG. 9B. Add purchase order interface 950 provides the user with an interface to enter various purchase order information that once submitted with populate a new order line 920 in purchase order screen 900. Add purchase order screen includes various fields for entry of data that corresponds to the various data items described in connection with FIG. 9A. As shown, the user enters the various information via various down menus and fields. Order number field 952 displays the order number for the purchase order, which includes an indicator of whether the item is a re-order (RO) or special purchase (SO) order. Order type dropdown 954 presents the type of order, which when selected appears in order number field 952. Vendor drop down 956 presents a listing of various vendors in the system, allowing the user to select the vendor that corresponds to this order. Terms drop down 960 allows the user to select the terms of the order with respect to the vendor. These include terms negotiated between the merchant and the vendor, including any applicable discounts and the like. The order date is selected via selectable order date calendar 958 and the due date is entered via selectable due date calendar 962. The anticipated shipping date is selected via selectable shipping date calendar 964. Order confirmation number field 966 receives entry of the order confirmation number, and order confirmation box 968 is marked or checked when placement of the order with the vendor is confirmed. Once the various information in add purchase order interface 950 is entered and saved, the information appears as a new order line 920 in purchase order screen 900.

The user can provide further details concerning a newly created purchase order via items screen 970 shown in FIG. 9C. Items screen allows the user to further define or provide more details concerning the items underlying the purchase order. This process starts with user selection of add new variant button 971. Next, the user enters a style number in item search field 972. This will present the user with the items associated with that style number that are included in the newly added purchase order. Upon entry of the style number, the quantity of items in a particular color and size that are included in the purchase order will be displayed to the user, along with the due date. The user modifies the due date via selectable calendar 974 and enters the cost and retail price of the items in cost field 976 and retail price field 978, respectively. The user may delete the product line via delete key 980 if, for example, the user learns that the item is no longer available for shipment. Once the user enters the desired information in items screen 970, the user saves the information by clicking save key 982.

Purchase orders are of various types, including special orders where the customer pays a deposit of an agreed amount, internet orders where the purchase pays for the item in full, lower orders, where the customer pays a fraction of the purchase price with the ability to return the item, reorder items that are reorders of items previously in stock or a market order containing new merchandise for the merchant.

Data such as purchase orders are editable. They are also deleted, either in full with historical data of the item deleted, or as a “soft delete” where an item subject to a purchase order is removed from the active view of purchase orders but the historical data associated with the item remains. Purchase orders are archived with archived orders viewable either individually or as part of an archive list. Purchase orders are also duplicated on request for ease of user information entry which when duplicated need not be re-entered.

Once the variant information as described with respect to FIG. 9C is saved, individual purchase order screen 985, as depicted in FIG. 9D, reflects this information. As shown, the single units of Sherri Hill dresses in size 2 in navy, size 8 in rosy brown and size 4 in magenta, with the cost information are now included in this purchase order. This purchase order information will also be included in the on order information for this style in the on order screen 300 as discussed in connection with FIGS. 3A-3C, with detailed information accessible by the user by selecting the various selectable units provided on order screen 300.

Merchant platform 100 also includes interfaces for entry and later access and report generation of additional information including sales history for a product for a given style.

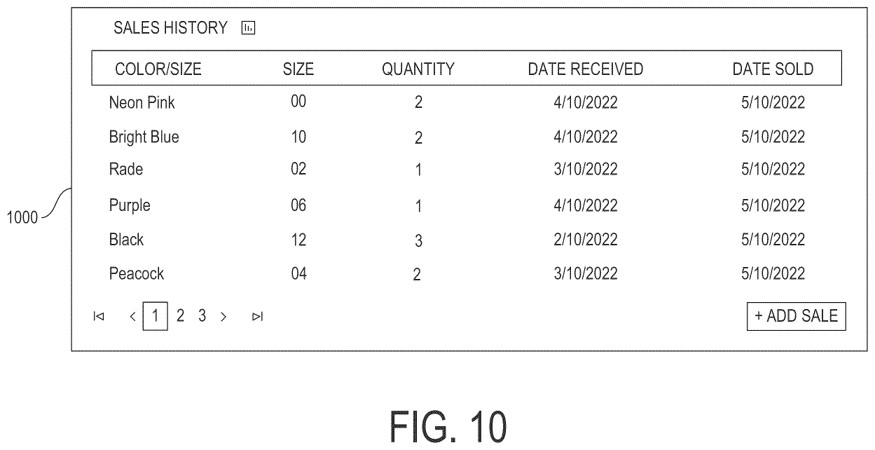

FIG. 10 depicts a sales history interface generated by a re-ordering and buying management system for specialty retailers according to an embodiment. Sales history interface 1000 in one embodiment provides the sales history for a particular style of garment, broken down by color, size and quantity. The sales history presented is customizable by the merchant. In one embodiment, sales history is displayed with most recent sales first. The user clicks add sales key 1002 to add other sales of an item not previously entered. Sales history interface 1000 in one embodiment is in table form with columns of additional information added, such as the date the item was received by the merchant, as shown.

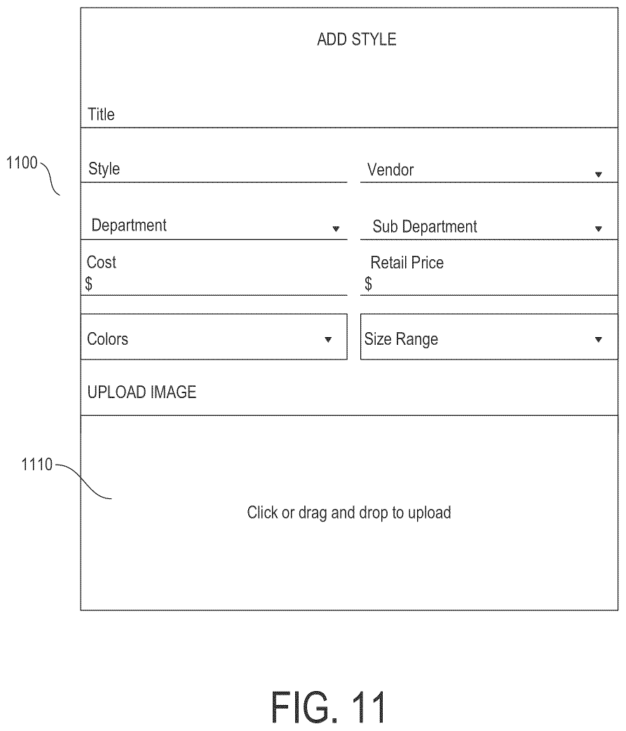

FIG. 11 depicts a style addition interface generated by a re-ordering and buying management system for specialty retailers according to an embodiment. Add style interface 1100 permits users of merchant platform 100 to add new product styles to merchant tracking platform. Add style interface 1000 includes various fields as reflected in other interfaces that depict the status of items already in platform 100, such as the item title or name, the style, the vendor, the merchant's department and sub-department, the item unit cost and retail price, any applicable terms with vendor, and available colors and sizes. Add style interface 1100 also includes upload image section 1110. Upload image section 1110 permits a user to upload via a drag and drop operation, file selection or other known technique to upload an image of the item style added in order to provide users with more information and a better understanding of the item.

The various interfaces of merchant platform 100 provide merchants with a robust mechanism for placing and tracking orders from virtually a limitless number of vendors for many different items of varying colors, sizes and styles. Merchant platform 100 generates customer alerts of deliver changes and other information that will impact the customer's decision-making process, particularly for merchants in time sensitive product businesses, such as sellers of garments for weddings, proms and the like, where timely delivery is critical. Merchant platform 100 also provides merchants with real time inventory data that prevents encumbering resources (storage space and capital) in unnecessary stock.

As described, merchant platform 100 provides a reordering system giving a historical view of the sales history of a given style to allow the merchant to make informed ordering decisions. Via the various style or item interfaces described, the user also makes pricing markdowns to various styles, inventory items based on age or combinations thereof. Various users within a merchant enterprise are assigned credentials giving the particular user the authority to add, modify or delete information saved to merchant platform 100 via the various interfaces. Merchant platform 100 also generates merchandise tickets that are a physical (paper) record of the sales information of an inventory item. Merchandise tickets physically prepared by merchant personnel serve as the source of input data for an inventory item in merchant platform 100, as described with respect to the aforementioned screens and interfaces.

Reorder system of merchant platform 100 via the customized application program through which the various transactions and data entry operations occur (in addition to other devices containing a processor) provides a comprehensive view of product data, market trends and item sales performance, providing the user with the ability to make more informed reordering decisions. Products are filterable according to various criteria, including department, sub-department, vendor and time period.

Other paper documents of transactions are generated from merchant tracking platform for purposes of redundant records or providing vendors or other parties with physical evidence of various transactions. Vouchers for shipping and receiving of purchase orders are generated reflecting completion or stages of completion of product delivery. Regular vouchers are generated when items that are the subject of a purchase order are received by the merchant from the vendor. Updating of screens and invoices of merchant platform 100 signifying various events, such as confirmation of delivery of an order, invoke the physical printing capability of the platform, generating a receipt for the vendor. Similarly, a vendor equipped or associated with a particular merchant's merchant platform 100 receives an email, SMS message or other electronic indication of fulfillment of an order. Reverse vouchers are generated in a similar manner when a mistake in the receiving process occurs, removing the item from the on hand table and from inventory. A return voucher is generated when an item is returned for damage or if the wrong item is delivered. The return voucher activation also deducts the item from the on hand table and from inventory.

Merchant platform 100 includes various other modules interrelated and affected by the product ordering and inventorying operations described. These modules relate to customer data, targeting advertising, notifications, user settings of both the merchant and third parties using the specially dedicated application program of the merchant tracking platform. User settings allow the user to customize presentation of data and management of preferences, such as receiving and sending notifications.

The re-ordering and buying management system as presently described also interfaces with third party platforms that process and generate marketing data and provide targeted advertising or other marketing information or promotions transmitted to users. Via merchant customers having devices equipped with application programs for execution of the functionality of the re-ordering and buying management system described herein, third party marketing platform operator content is forwarded to the merchant customer through known techniques such as in-application program notifications, event based notifications, email notifications and push notifications. Customers and merchant users and administrators of the presently described embodiments of the re-ordering and buying management system customize preferences for receiving such notification concerning advertising, events, alerts or updates of pertinent information. Users may also subscribe or unsubscribe for the receipt of messaging pertaining to a particular topic or subject matter.

Alternatively, the merchant purchases third party marketing platform content and brands it as the merchant's and presents such marketing content directly to its customers via customer device 172 equipped with the merchant's application program.

Other features that greatly add to the robustness of merchant platform 100 of the presently described re-ordering and buying management system for specialty retailers are an employee management module.

A customer module is invoked by the various user terminals, that include but are not limited to the POS device 142 or administrator termina 114 used by retailer employees whether on the sales floor or at various locations in or remote from the retailer's place of business, where enrolled or recognized customer information is updated based on a new transaction or completed transaction. This allows the merchant to create enhanced customer experiences. Merchants optionally provide customers enrolled in merchant tracking platform with enrollment in a loyalty program, conferring upon customers added benefits enhancing the customer experience and providing pricing discounts and the like, encouraging repeat business. A merchant can categorize customers in groups, leveraging the groupings or other customer assigned attributes in target advertising initiatives that promote to customers other products, services or combinations thereof provided by the merchant or various merchant partners. Artificial intelligence techniques, known in the art, are invoked to process customer data and make recommendations for products, services, discounts and other commercial opportunities that may be of interest to the customer. These techniques are performed by artificial intelligence (AI) software module 190 executed by processor 102 of merchant platform 100. As described, customer information is stored in customer database 108 of merchant tracking platform 100.

In contrast to purely manually recorded and tracked information of, various software modules of the presently described enables computerized input and storage of data relating to particular garment styles of a vendor. Through the various user interfaces and screens of the presently described re-ordering and buying management system, a merchant is presented with product purchase and sales data and inventory information in various graphical forms.

Single item data stored in inventory database 106 contains data related to various styles of a garment, colors and sizes available and the number of units sold, on order, or in inventory of each. The contents of inventory database 106 of FIG. 1 are the source of reports generated by the user to track data related to individual items, such as garments, and individual sizes and colors, associated with a vendor, or according to time periods of interest when a product or products were sold, ordered, or entered inventory. The user of the presently described re-ordering and buying management system sets the needed amount of granularity for report generation or data presentations to service the merchant's needs at the moment.

The various functionalities herein described in the form of report generation, inventory management, employee management, customer experience enhancement and the like are provided to the merchant user of the presently described re-ordering and buying management system for specialty retailers through a device having a user interface such as a smart phone, tablet or other portable device made available to merchant personnel. A custom application program 141 associated with merchant server POS device 142 is downloadable to or accessible by the various merchant user devices. Application program that when executed by the processor associated with administrator terminal 114 or point of sale devices 142 enables merchant user execution of the various operations described herein. Through the display screen of POS device 142, the merchant user is able to easily decipher product details, which is facilitated by a visual image of the item, such as a formal gown of a particular color, size or style of a vendor. Through POS device the merchant user, often a clerk on the sales floor of the merchant or back room personnel, is presented with the number of units sold of the item identified in a style field for the particular vendor identified in a dedicated field. The presented data breaks out units sold of the particular item of the particular vendor according to garment color and size.

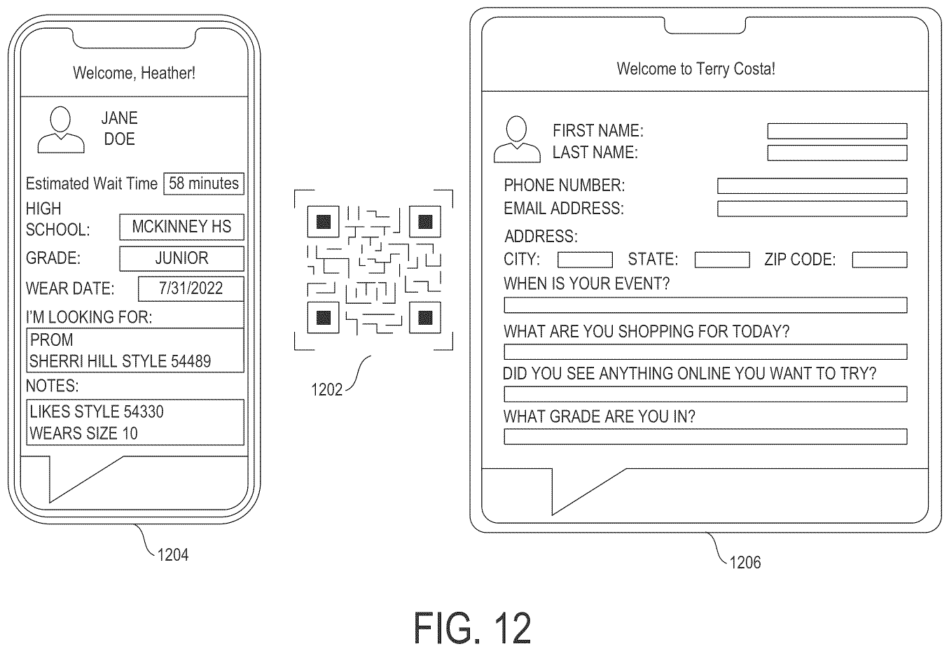

FIG. 12 depicts components of a customer check in screen as presented to the user on a customer smartphone device or other portable digital device according to an embodiment. A merchant provides QR code 1202 to customers upon entry of the store and in locations throughout the store via signage placed at strategic locations. A user through smartphone 172 (FIG. 1) scans QR code 1202, which invokes an enrollment screen 1206. If the user has not previously registered or enrolled with the merchant, either in person or via a digital device, a “welcome” screen with be provided. Through this screen the user enters various information including name, cell phone number, email address, mailing address and other relevant information. The entered user information is saved in customer data store 108 of merchant platform 100. A similar interface is available via POS device 142, where the merchant user employee enrolls the customer via the POS device rather than the user enrolling via his or her smartphone or other device.

If, however, the user has previously registered, the user will have a dedicated application program for the merchant establishment. Upon scanning the QR code, if the user has registered, the user's profile will be presented to the user via the user's device. The existing user screen 1204 provides the user's information and other information, including a wait time that the user can expect to be personally served. The wait time feature is particularly useful during busy seasons, such as prom season, allowing the user to “check in” and tend to other tasks or errands while waiting for service.

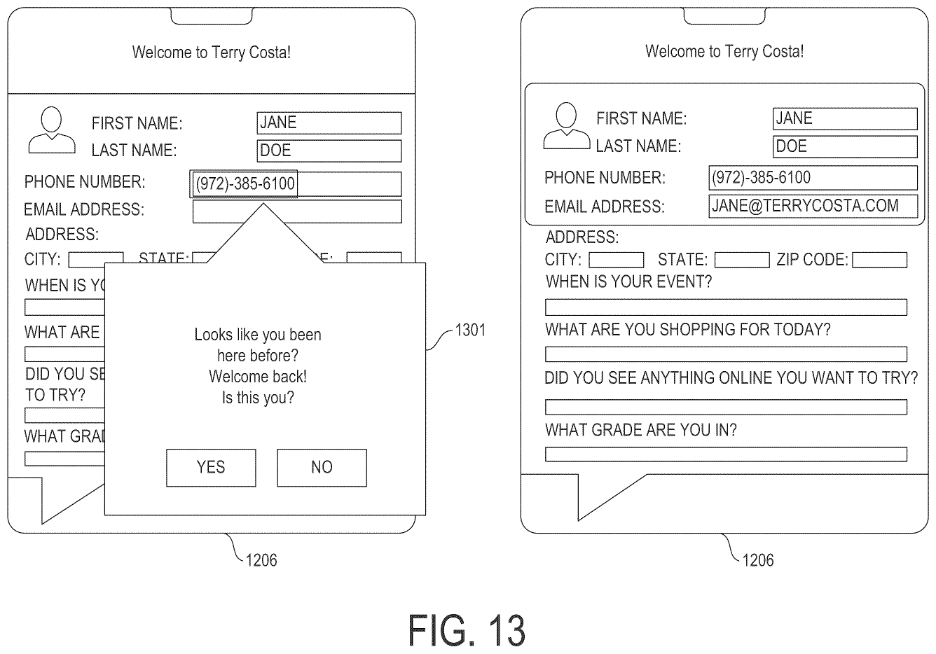

FIG. 13 depicts a pre-population feature of the enrollment screen 1206 of FIG. 12 according to an embodiment. If the user does not receive a “welcome back” screen 1504 for previously registered users, based on failure to download the dedicated application program or a long period of time between visits, registration window will recognize various attributes entered by the user that match data stored in customer data store 108 of merchant platform 100. In one embodiment, if a user enters a name that matches a name within customer data store 108, a pop up window 1301 will appear, with a phone number populating the phone screen with the message that it appears the customer has visited the merchant before and the query “Is this you?” If the user answers “yes”, then the email stored for the user in customer data store 108 is automatically entered into the form, and the customer is able to update the remaining information. New user information is overwritten to the data for this user in customer data store 108. The completed basic user information area 1304 is populated.

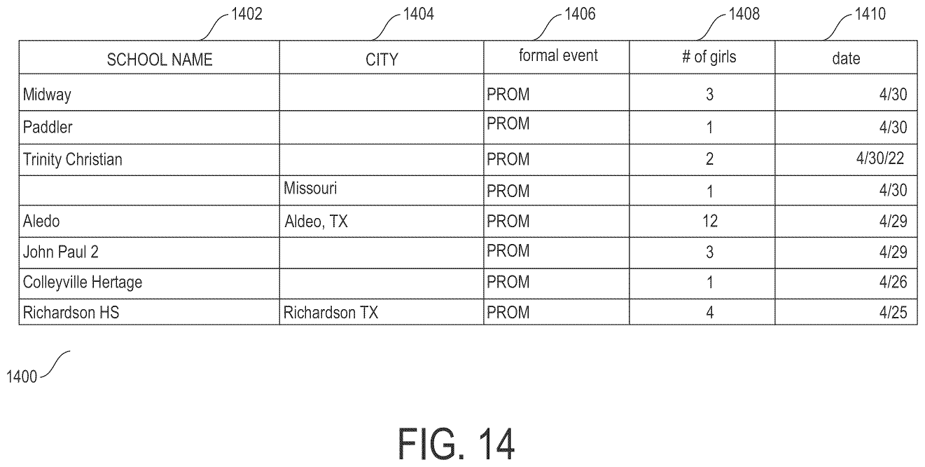

FIG. 14 depicts event report 1400 generated by merchant platform 100 based on customer information retrieved at the point of sale by point-of-sale devices 142 or administrator terminal 114 or other associated retailer computer or digital device. Events report 1400 includes a number of fields from user data collected in connection with a merchant's customer transaction. In the example of FIG. 14, events report 1400 centers around prom season, which is a peak event for retailers of formalwear. Events report 1400 includes a number of fields including school name field 1402, school city field 1404, particular event field 1406, number of relevant people field 1408, and date of event field 1410.

The presently described merchant re-ordering and buying management system allows users to search for customer information according to various customer attributes stored in customer store 108. Searchable customer information includes customer first and last name, the customer's school, the customer's cell phone or work number, the customer type, a customer identification number, the customer's initial sale date, and the customer's last sale date.

The dedicated user application in one embodiment is invoked when the user's smartphone 172 or other device is sensed within the store based on a location sharing feature on the user phone, or upon the user scanning the merchant's QR code as discussed. Customer information such as that discussed in connection with FIG. 14 or other customer demographic information, including the fact that the customer attended the store on a particular day, are compiled, stored and used as analytical data to assist merchant in marketing efforts, staff scheduling, inventory control, hours of operation and the like. Data related to where the customers reside and the event(s) they are attending are key data in effective marketing.

The merchant's ability to communicate with the user in real time is the product of the sales personnel's point of sale digital device or the user's device equipped with the merchant's application program. The customer through the dedicated application program on smartphone 172, while the customer is in the queue for service, selects garments to try on. Platform 100 creates a customer ticket for the current day's visit on which various garments according to the vendor, style, size and color are listed according to the customer's selection. At the same time, the sales clerk through its POS device checks product availability according to customer selections and places available garments for the customer to view and try on on the garment racking system, streamlining the customer experience process enabling the merchant to efficiently assist more customers.

Additionally, the customers data is pre-loaded across all POS devices 141 managed by personnel throughout the store, including at check out. This eliminates the need for merchant personnel to re-enter customer data at checkout.

Merchant platform 100 integrates online customer ordering and brick and mortar ordering into a single set of reports usable by the merchant. Purchase orders, regardless of where sourced are generated and directly transmitted to the vendor's warehouse for fulfilment and deliver. Further, when an order is placed for a particular event, an email is generated and sent to the email address of the purchaser providing the customer with various information concerning the order ship date, the purchase price and promotional information.

Merchant platform 100 creates purchase orders associated with each customer transaction. Purchase order that are filled are archived in purchase order data store 110. Platform 100 allows retrieval of particular purchase orders associated with a particular customer or vendor. In addition, the merchant can generate reports of archived purchase orders. Platform 110 includes administrator terminal 114 that provides the user with a graphical user interface or dashboard that provides a visual representation via a list or otherwise of purchase orders that are past the completion date or will be past the completion date within a certain time (day, week, month) as selected by the merchant. This enables the merchant to update the customer of the status of orders and possible delays well in advance of the upcoming event.

Through the merchant dashboard, purchase orders that are past the stated cancelation date but the order is ready to be filled are restored as of the date the order is to be filled, with the cancellation date changed to the date the purchase order is restored.

The customer's selections for purchase of items available in the store or requiring ordering populate a purchase order that is transmitted to the merchant's POS devices 142 (FIG. 1) at checkout. The merchant platform 100 administrator can set attributes such as product discounts for various items purchased or for linked items. For example, if a purchase is made of a product of a particular vendor or department, a discount for a separate item purchased is provided. Merchant platform 100, via POS device 141 or administrator terminal 114, provides the functionality for merchants to link various discounts and specials such as these to items for a limited pre-defined duration. Similarly, customer accounts having in excess of a pre-defined duration as a customer or exceeding a pre-defined level of dollars spent or items purchased over a predefined period can be designated to receive various offers. Notably, in an embodiment the functionality of the herein described re-ordering and buying management system operates via processor 102 and associated application programs 107 of merchant platform, accessed by other computer products, such as administrator terminal 114. Administrator terminal 114 is located at the retailer place or business and communicates via wired or wireless connection with merchant platform 100. Other devices in communication with merchant platform communicate over the internet 180 or other wide area network or via wired or wireless network. These devices include but are not limited to point of sale devices 142 or other user devices co-located at the retailer location or remotely. Overall, the ability of retailer personnel to make informed, fast and accurate product re-ordering decisions is made available to users of the presently described re-ordering and buying management system whether done through the various user interfaces made available and accessed via various computer devices.

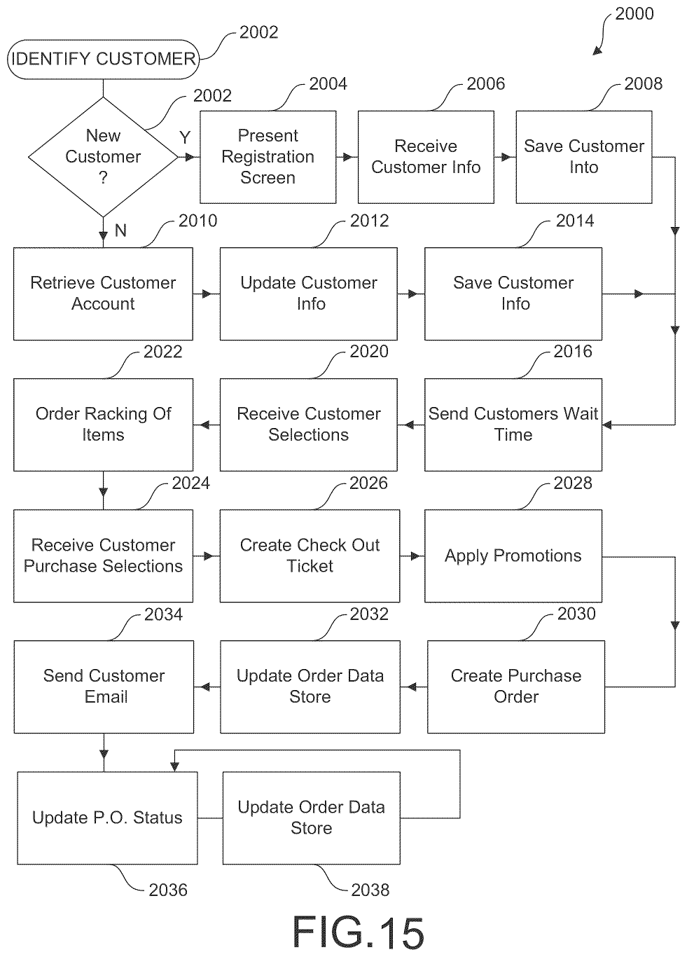

FIG. 15 is a flowchart of a process performed by merchant re-ordering and buying management system according to an embodiment. The customer enrollment and order method 2000 begins at step 2002 where platform 100 identifies a customer. The customer is identified either by the customer scanning a QR code at the brick and mortar location, or invoking a new customer experience or new visit at the store via the merchant's own application program downloaded to the user's smartphone or personal digital device. At step 2002, platform 100 queries whether the customer is a new customer. If the answer is yes, meaning the customer has not previously registered with the user, platform 100 presents the customer with an enrollment or registration screen on the customer's device at step 2004. Next at step 2006, platform 100 receives customer information and at step 2008 stores the customer information, such as name, phone number, email address in customer data store 208. Optionally platform 100 sends to the customer device welcoming information, special offers and the like.

Alternatively, if the customer is not a new customer at step 2002, at step 2010 platform 100 retrieves the existing customer's account. At step 2012 platform 100 updates the customer information, including the fact of the customer's visit on that particular day and at step 2014 any updated customer information is saved in customer data store 108.

After either step 2008 or step 2014, the process continues at step 2016 where a customer wait time to be served by sales personnel or enter a fitting room is sent to the customer device. Next, platform 100 receives customer items of interest selections at step 2020. In response to receipt of the customer selections of items for fitting, platform 100 generates a racking order at step 2022. This racking order is transmitted to store sales personnel for preparing the items for fitting for that particular customer. Thus, once a fitting room is available to the customer, the garments that the customer wishes to try on are ready and waiting for the customer.

Next, at step 2024, platform 100 receives the customer's input of items selected for purchase. This is generated in response to the selections made by the user on the user's personal device equipped with the merchant's application program, or via input by a sales associate via the merchant point of sale device. Then, at step 2026 a checkout ticket is generated and submitted directly to the merchant check out point of sale device. This eliminates wasted time in terms of the check out clerk having to re-enter customer and product information. Then, at step 2028 any promotional offers are presented to the customer. These offers, as discussed above, are based on a variety of factors, such as products offered at a discount when purchased together with the product of a particular type or sourced to a particular vendor. Also, promotions are based on the customer's historical purchase data, such as amount or number of transactions over a merchant defined period of time or as a new customer.

Process 2000 continues at step 2030 with the generation by platform 100 of a purchase order. In one embodiment purchase order is generated once the customer pays monies required by the merchant to place the order with the vendor. The required monies can be the entire purchase price or some lesser amount as a deposit, according to the merchant's or vendor's requirements. Once monies required, if any, are paid, a purchase order is generated. The purchase order includes a unique identification number, an order expected delivery date, a order taken date, and a cancellation date, which is the date by which the order is to be cancelled based on an unexpected vendor delay or inability to fulfil the order. At step 2032 the purchase order data store 110 is updated to reflect the order. Customer data store 108 is updated as well to reflect this customer's new purchase activity. Next at step 2034, the customer is sent an email, text message communication or other SMS message viewable by the customer through his or her smartphone, personal computer or other personal digital device outlining the details of the order and providing the purchase order unique identifier.

Next at step 2036, the purchase order status is updated. Updates are in the form of order completion or delivery dates, or changes in expected delivery dates, surpassing the expected delivery date or providing a notification that the cancellation date is a pre-defined period (day, week, month, etc.) away. Finally, at step 2038, the purchase order data store 110 is updated with the new order status information. Next, the process reverts back to step 2036 for additional updates regarding completion of the order, further delay, changes in expected delivery or restoring an order despite the cancellation date passing.

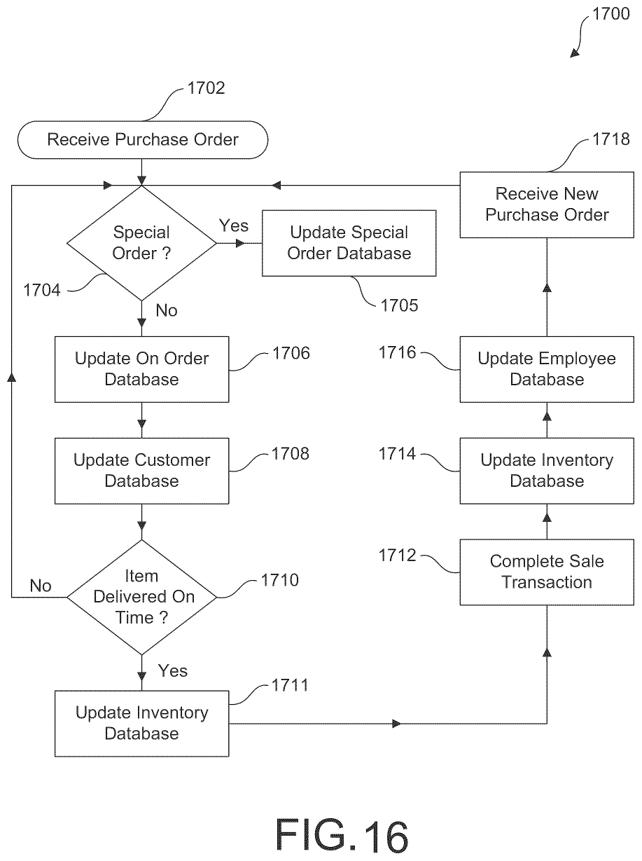

The method described in process 2000 of FIG. 15 is in no way limiting. Additional or alternative steps can be inserted based on additional interaction between the customer and sales personnel as designated by the merchant to make the purchasing, ordering and inventory process more efficient. With each order completed according to the process of FIG. 16 or otherwise, for product units that are ordered and kept on hand by the merchant, inventory store 106 is updated and inventory data pertaining to a particular vendor item, broken down by style, color and size is recorded as an on hand item. Inventory data is presented to the merchant users via the various views made available to the user via user interface 114 of FIG. 1 via administrator terminal 114 or the one or more point of sale devices 142.

FIG. 16 is a flow diagram of a purchase order process performed according to an embodiment of a merchant re-ordering and buying management system for specialty retailers. Purchase order process 1700 begins with step 1702 where the merchant platform receives from administrator terminal 114 or point of sale device a purchase order. The purchase order is an order placed by the merchant to a vendor for one or more units of one or more products, in this example garments, of a particular style, size and color. At step 1704 merchant platform queries whether the received order is a special order item. A special order item is one that will not be reflected in the merchant's general inventory of items that are available for off the rack purchase. If the answer to the query at step 1704 is yes, then at step 1705 the special order database of the merchant platform is updated to reflect the attributes of the special order. That is, the order date, the expected delivery date, the terms of sale and the style number, number of units ordered, the color and size of each unit ordered, the purchase order, and respective customer information is stored in the special order database.

If the answer at step 1704 is “no”, then the order is a regular order or a re-order generally stocked items and on order database is updated at step 1706 to store the order date, the expected delivery date, the terms of sale and the style number, number of units ordered, the color and size of each unit ordered. Next at step 1708, the customer database is updated to reflect the order placed by the customer. This includes setting a notification flag for informing the customer when the item ordered is available for pickup or whether the item's delivery has been delayed.

Next, at step 1710 merchant platform queries whether the item or items underlying the purchase order have been delivered on time. If the answer to query 1710 is “no” then the method reverts back to the query of step 1704 and the merchant platform updates either the special order database or on order database and customer database, as described. If, one the other hand, the answer at query 1710 is yes and the items were delivered on time, then the process proceeds to step 1711 where the merchant platform updates the inventory database to reflect that the items are a part of overall inventory. Note that as part of the inventory database update, on hand items will reflect regular item orders or re-orders, meaning that these units are available for sale by the merchant to any customer. On the other hand, if the items are special order items, although these items are reflected in overall merchant inventory data, the special items are not included in on hand data as the sale of these special order items are reserved for the ordering customer. The special order items that are on hand or on order are portrayed in the specials on hand or specials on order tables, respectively.

Once the item is received, the sale transaction to the customer is completed at step 1712. This entails the customer visiting the merchant location or calling by phone or contacting via an online process and paying any balance due on the special item order, or the customer purchasing the regular or re-ordered item from general inventory. This transaction can also occur online via an application program residing on the user's device that interfaces with any of the merchant's devices or the merchant platform, or both. Next at step 1714, once the item is sold, at step 1714 the inventory database is again updated to reflect that the sold item, whether a special order item or regular or re-ordered item, is no longer in inventory. Next at step 1716, the employee database is updated to reflect that the sale of the item is attributable to one or more employees. The retail price, units sold and customer information associated with the sale are stored in connection with the unique account of the employee or employees involved in the transaction. This information from the employee perspective is used by the merchant platform to process employee and scheduling efficiency, profitability, and any commission or other compensation to be attributed to the employee. Finally at step 1718, a new purchase order is received at the merchant platform as entered by any merchant associated devices or is directly entered via the administrator terminal associated with the merchant platform, and the process repeats at step 1704, with the query of whether the item underling the purchase order is a special order item.

The merchant re-ordering and buying management system as presently described also leverages customer transaction data collected by merchant employees on the sales floor and stores sales and customer experience data in employee data store 112. Data related to sales attributable to an employee are stored in data store 112. In addition, the customer may review the customer experience with the employee via customer device 172 or 174, with such reviews stored in employee data store 112. Each employee is provided with a unique identifier and the various data stored in each data store is associated with that employee identifier. At the start of the employee's shift, the user logs in or clocks in via the point-of-sale device 142 assigned to the employee for his or her shift. Armed with data concerning the number of customers served by the employee, the number of items sold, the cost and retail price of the items sold and the number of hours worked by the employee allows the merchant to evaluate the efficiency and profitability of the various employees. Customer reviews or comments of the customer's experience with the employee are stored and considered by the merchant when making management decisions regarding the employee, whether positive or negative.

In addition, each employee's personnel information, such as information associated with state and federal payroll requirements, the employee's address and status, and other information is stored in data store 112 and is associated with the employee's unique identifier. Further, the merchant's payroll software retrieves data stored in data store, in particular related to customer sales by that employee during a particular pay period to attribute applicable commissions earned by the employee, bonuses or the like that are paid to the employee via the standard payroll process.

Merchant platform via its various application programs when executed permit the merchant to generate various customizable reports on a single employee or multiple employee performance. Likewise, through the merchant interface, which may be accessed through any merchant device, such as administrator terminal 114, or point of sale device 142, or other associated merchant computer, assuming the user is properly credentialed, visual depictions of the efficiency of one or all employees during a particular time period are tracked. This allows a merchant to determine the most efficient scheduling of employees to work during high sales volume times versus low volume times. This aids merchants in more efficient allocation of labor. Similarly, the merchant is able to glean which employees may be underperforming or performing as or beyond what is expected. Merchants are also keyed into which customer demographic is more in tune or is more likely to buy from one employee over another. In sum, merchant platform 100 processes and leverages various employee information to provide the merchant with more information to improve profitability.

The presently described merchant re-ordering and buying management system performs various back office tasks such as report generation concerning sales, inventory management, and employee management as described. Periodic data back up and security for protection of customer and merchant data is also provided by dedicated software modules executed by merchant platform 101. In the event of network failure, merchant platform 100 operates in “off-line” mode, permitting business operations to continue and sales data to be locally stored in the various merchant devices (administrator device, point of sale, etc.) until network operation is restored and data can be processed as usual.

Numerous reports in visual or textual form are generated by the presently described merchant re-ordering and buying management system. Reports reflecting daily product receiving, special order pickup and deliveries, issued special orders, sales receipt journals, quantities on hand, quantities on order, quantities on layaway may be reported according to various reporting parameters such as for a particular vendor, item, style, color, size, time period or various combinations of these parameters and others. Other reports generated relate to style analysis, web inventory, POS flag report concerning for example a discount code used by a customer or how the customer heard of the merchant, sales associate reports, internet inventory on order, employee check in and out data, sales item summaries, best item sale data by department, sales store summaries, best style sales by vendor by units, units committed to special orders, top number of styles on hand or on order, rankings of merchandise on hand or on order according to quantity, profit (which may be tied to data processed by third party accounting software, past, pending and completed orders and various other reports reflecting the data collected and stored by merchant platform 100. These customizable reports are presented to authorized users via a user dashboard and may be archived for later review.

The robust functionality of merchant platform 100 is enabled by various software modules stored locally or remotely and accessible by processor 102. Processor 102 comprises a processing core for executing program instructions and accessing data from a memory. It should be appreciated that one of the unique features believed characteristic of the present application is that merchant platform 100 integrates product purchase order data associated with various customers, sourced to various vendors and purchased either at brick-and-mortar locations or online into a single purchase fulfilment and inventory tracking system. Data collected from customers and date pertaining to sold units are aggregated and used for effective marketing efforts and better allocation of resources. to properly bid on a work request. It will be appreciated that thereby the need for manual collection and updating of purchase order and inventory data or maintaining separate purchase order and inventory systems for brick and mortar sales and online sales is eliminated.

As generally illustrated herein, the system embodiments of the present disclosure can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. The present disclosure includes this type of computer readable media within its scope. The presently disclosed system anticipates a wide variety of variations in the basic theme of construction. The examples presented previously do not represent the entire scope of possible usages. They are meant to cite a few of the almost limitless possibilities. One skilled in the art will recognize that other embodiments are possible based on combinations of elements taught within the above description. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

### ADDITIONAL DISCLOSURE

Clause 1. A merchant re-ordering and buying management system, comprising:
a processing core for executing computer instructions and accessing data from a memory; and
a non-volatile storage medium for storing the computer instructions, wherein the processing core, the non-volatile storage medium, and the computer instructions are configured to implement a re-ordering and buying management system, comprising:
a computer terminal comprising a processor, a memory, a display, a payment card reader a network communication medium and an inventory, customer and employee management application program stored in the memory, and a network communication medium;
a graphical user interface generator for generating interactive user screens comprising merchant items having a plurality of selectable merchant item attribute for display on the computer terminal;
an inventory report generator invoked by user selection of one of the plurality of selectable merchant item attributes displayed on the computer terminal for generating an inventory graphical representation of inventory data associated with the selected one of the plurality of selectable merchant item attributes;
an order report generator invoked by user selection of a one of a plurality of merchant item style attributes on the computer terminal for generating a first order status graphical representation of items order data associated with the selected merchant item style;
a new purchase order form generator for generating a new purchase order form invoked by the computer terminal receipt of a customer order of an ordered purchase item;
a customer account database comprising a customer identification data and historical customer purchase data uniquely associated with an individual customer account; and
an employee database comprising employee data uniquely associated an individual employee,
wherein the historical customer purchase data is updated upon completion of a customer purchase,
wherein the employee data is updated upon the employee completion of a customer transaction.

Clause 2. The merchant re-ordering and buying management system of the preceding clause, wherein the selectable user item attribute comprises an item size, an item color, an item quantity, and an item supplier.

Clause 3. The merchant re-ordering and buying management system of any preceding or proceeding clause, wherein the order report generator invoked by user selection of the one of the plurality of merchant item style attributes on the computer terminal for generating a second order status graphical representation of items order data associated with the selected merchant item style.

Clause 4. The merchant re-ordering and buying management system of any preceding or proceeding clause, wherein the first order status graphical representation of items order data associated with the selected merchant item style comprises a re-ordered merchant item.

Clause 5. The merchant re-ordering and buying management system of any preceding or proceeding clause, wherein the second order status graphical representation of items order data associated with the selected merchant item style comprises a special order merchant item.

Clause 6. The merchant re-ordering and buying management system of any preceding or proceeding clause, wherein generating an inventory graphical representation of inventory data associated with the selected one of the plurality of selectable merchant item attributes comprises generating comprises on-hand inventory data.

Clause 7. The merchant re-ordering and buying management system of any preceding or proceeding clause, wherein generating an inventory graphical representation of inventory data associated with the selected one of the plurality of selectable merchant item attributes comprises generating comprises on-order inventory data.

Clause 8. The merchant re-ordering and buying management system of any preceding or proceeding clause, wherein generating an inventory graphical representation of inventory data associated with the selected one of the plurality of selectable merchant item attributes comprises generating comprises special order inventory data.

Clause 9. The merchant re-ordering and buying management system of any preceding or proceeding clause, wherein generating an inventory graphical representation of inventory data associated with the selected one of the plurality of selectable merchant item attributes a merchant item delivery date.

Clause 10. The merchant re-ordering and buying management system of any preceding or proceeding clause, wherein an inventory data stored in an inventory database is updated upon completion of a transaction at the computer terminal.

Clause 11. The merchant re-ordering and buying management system of any preceding or proceeding clause, wherein an order data stored in an order database is updated upon completion of a transaction at the computer terminal.

Clause 12. The merchant re-ordering and buying management system of any preceding or proceeding clause, wherein the employee data comprises a workday start time of the employee, a workday end time of the employee, a quantity of merchant items sold by the employee, a quantity of customers serviced by the employee, a customer evaluation of the employee and a monetary value of merchant items sold by the employee.

Clause 13. The merchant re-ordering and buying management system of any preceding or proceeding clause, further comprising an advertisement generator module for generating an advertising content for delivery to a merchant customer according to a customer profile and a historical customer data.

Clause 14. The merchant re-ordering and buying management system of any preceding clause, further comprising a redundant data storage module for storage of a backup file of transaction data.

What is claimed is:

1. A merchant re-ordering and buying management system, comprising:
a processing core for executing computer instructions and accessing data from a memory; and
a non-volatile storage medium for storing the computer instructions, wherein the processing core, the non-volatile storage medium, and the computer instructions are configured to implement a re-ordering and buying management system, comprising:
a computer terminal comprising a processor, a memory, a display, a payment card reader a network communication medium and an inventory, customer and employee management application program stored in the memory, and a network communication medium;
a graphical user interface generator for generating interactive user screens comprising merchant items having a plurality of selectable merchant item attribute for display on the computer terminal;
an inventory report generator invoked by user selection of one of the plurality of selectable merchant item attributes displayed on the computer terminal for generating an inventory graphical representation of inventory data associated with the selected one of the plurality of selectable merchant item attributes;
an order report generator invoked by user selection of a one of a plurality of merchant item style attributes on the computer terminal for generating a first order status graphical representation of items order data associated with the selected merchant item style;
a new purchase order form generator for generating a new purchase order form invoked by the computer terminal receipt of a customer order of an ordered purchase item;
a customer account database comprising a customer identification data and historical customer purchase data uniquely associated with an individual customer account; and
an employee database comprising employee data uniquely associated an individual employee,
wherein the historical customer purchase data is updated upon completion of a customer purchase,
wherein the employee data is updated upon the employee completion of a customer transaction.

2. The merchant re-ordering and buying management system of claim 1, wherein the selectable user item attribute comprises an item size, an item color, an item quantity, and an item supplier.

3. The merchant re-ordering and buying management system of claim 1, wherein the order report generator invoked by user selection of the one of the plurality of merchant item style attributes on the computer terminal for generating a second order status graphical representation of items order data associated with the selected merchant item style.

4. The merchant re-ordering and buying management system of claim 1, wherein the first order status graphical representation of items order data associated with the selected merchant item style comprises a re-ordered merchant item.

5. The merchant re-ordering and buying management system of claim 3, wherein the second order status graphical representation of items order data associated with the selected merchant item style comprises a special order merchant item.

6. The merchant re-ordering and buying management system of claim 1, wherein generating an inventory graphical representation of inventory data associated with the selected one of the plurality of selectable merchant item attributes comprises generating comprises on-hand inventory data

7. The merchant re-ordering and buying management system of claim 1, wherein generating an inventory graphical representation of inventory data associated with the selected one of the plurality of selectable merchant item attributes comprises generating comprises on-order inventory data.

8. The merchant re-ordering and buying management system of claim 1, wherein generating an inventory graphical representation of inventory data associated with the selected one of the plurality of selectable merchant item attributes comprises generating comprises special order inventory data.

9. The merchant re-ordering and buying management system of claim 1, wherein generating an inventory graphical representation of inventory data associated with the selected one of the plurality of selectable merchant item attributes a merchant item delivery date.

10. The merchant re-ordering and buying management system of claim 1, wherein an inventory data stored in an inventory database is updated upon completion of a transaction at the computer terminal.

11. The merchant re-ordering and buying management system of claim 1, wherein an order data stored in an order database is updated upon completion of a transaction at the computer terminal.

12. The merchant re-ordering and buying management system of claim 1, wherein the employee data comprises a workday start time of the employee, a workday end time of the employee, a quantity of merchant items sold by the employee, a quantity of customers serviced by the employee, a customer evaluation of the employee and a monetary value of merchant items sold by the employee.

13. The merchant re-ordering and buying management system of claim 1, further comprising an advertisement generator module for generating an advertising content for delivery to a merchant customer according to a customer profile and a historical customer data.

14. The merchant re-ordering and buying management system of claim 1, further comprising a redundant data storage module for storage of a backup file of transaction data.
